(19) United States
(12) Patent Application Publication
(10) Pub. No.: US 2021/0019606 A1
(43) Pub. Date: Jan. 21, 2021

(54) CELLULAR NEURAL NETWORK INTEGRATED CIRCUIT HAVING MULTIPLE CONVOLUTION LAYERS OF DUPLICATE WEIGHTS

(71) Applicant: Gyrfalcon Technology Inc., Milpitas, CA (US)

(72) Inventors: Lin Yang, Milpitas, CA (US); Baohua Sun, Fremont, CA (US); Yongxiong Ren, San Jose, CA (US); Wenhan Zhang, Mississauga (CA)

(73) Assignee: Gyrfalcon Technology Inc., Milpitas, CA (US)

(21) Appl. No.: 16/516,222

(22) Filed: Jul. 18, 2019

(51) Int. Cl. G06N 3/063; G06K 9/00; G06T 1/60; G06N 3/04; G06N 3/08

(52) U.S. Cl. CPC G06N 3/063; G06K 9/00979; G06N 3/084; G06T 1/60; G06N 3/04; G06K 9/00986

(57) ABSTRACT

An integrated circuit may include multiple cellular neural networks (CNN) processing engines coupled to at least one input/output data bus and a clock-skew circuit in a loop circuit. Each CNN processing engine includes multiple convolution layers, a first memory buffer to store imagery data and a second memory buffer to store filter coefficients. Each of the CNN processing engines is configured to perform convolution operations over an input image simultaneously in a first clock cycle to generate output to be fed to an immediate neighbor CNN processing engine for performing convolution operations in a next clock cycle. The second memory buffer may store a first subset of filter coefficients for a first convolution layer of the CNN processing engine and store a reference location to the first subset of filter coefficients for a second convolution layer, where the filter coefficients for the first and second convolution layers are duplicate.

### FIELD

This disclosure relates generally to artificial intelligence semiconductor solutions and examples of cellular neural network integrated circuit and method of training the same are provided.

### BACKGROUND

Artificial intelligence (AI) semiconductor solutions include using embedded hardware in an AI integrated circuit (C) to perform AI tasks. Hardware-based solutions for performing AI tasks, such as using a cellular neural network (CNN) integrated circuit, may provide advantages of fast computations but may also suffer from limited hardware resources. For example, an embedded CNN in a semiconductor chip may have a limited number of convolution layers. The semiconductor chip may also have limited memory space for storing the weights of the convolution layers of the CNN. These constraints may limit the capabilities or performance of the AI integrated circuit.

### BRIEF DESCRIPTION OF THE DRAWINGS

The present solution will be described with reference to the following figures, in which like numerals represent like items throughout the figures.

FIG. 1 is a schematic diagram of a portion of an example CNN processing block according to some examples described in the disclosure.

FIG. 2A is a schematic diagram of a CNN processing engine according to some examples described in the disclosure.

FIG. 2B is a schematic diagram of multiple CNN processing engines in a semiconductor chip according to some examples described in the disclosure.

FIG. 3 is a schematic diagram of a controller of a CNN processing engine according to some examples described in the disclosure.

FIG. 4A is a schematic diagram of an example CNN processing engine according to some examples described in the disclosure.

FIGS. 4B and 4C are example memory blocks in a CNN processing engine according to some examples described in the disclosure.

FIG. 4D is an example memory block of filter coefficients in a CNN processing engine according to some examples described in the disclosure.

FIG. 5 is a flow diagram of an example process of performing CNN operations that may be implemented in a CNN processing engine according to some examples described in the disclosure.

FIG. 6 is a diagram showing pixel locations within a sub-region according to some examples described in the disclosure.

FIGS. 7A-7C are diagrams showing three example pixel locations according to some examples described in the disclosure.

FIG. 8 is a diagram illustrating an example data arrangement for performing convolutions at a pixel location according to some examples described in the disclosure.

FIG. 9 is a function block diagram illustrating an example circuitry for performing convolutions at a pixel location according to some examples described in the disclosure.

FIG. 10 is a diagram showing an example rectification according to some examples described in the disclosure.

FIGS. 11A-11B are diagrams showing two example pooling operations according to some examples described in the disclosure.

FIG. 12 is a diagram illustrating reduction of pixels in a pooling operation according to some examples described in the disclosure.

FIGS. 13A-13C are diagrams illustrating examples of image blocks in an input image according to some examples described in the disclosure.

FIG. 14 is a diagram illustrating an example set of memory buffers for storing received imagery data according to some examples described in the disclosure.

FIG. 15 is a diagram showing two operational modes of an example set of memory buffers for storing filter coefficients according to some examples described in the disclosure.

FIG. 16 is a schematic diagram showing a plurality of CNN processing engines for performing convolution operations according to some examples described in the disclosure.

FIGS. 17A-17C are example data patterns of imagery data and filter coefficients for performing convolution operations over various layers in a first example using multiple CNN processing engines according to some examples described in the disclosure.

FIGS. 18A-18C are example data patterns of imagery data and filter coefficients for performing convolution operations over various layers in a second example using multiple CNN processing engines according to some examples described in the disclosure.

FIG. 19A is a flow diagram of an example process of arranging imagery data and filter coefficients of a CNN processing engine for performing an AI task according to some examples described in the disclosure.

FIG. 19B is a flow diagram of an example process of performing an AI task using multiple CNN processing engines according to some examples described in the disclosure.

FIG. 20 is a diagram showing an example data arrangement of imagery data according to some examples described in the disclosure.

FIG. 21 is a diagram showing an example data arrangement of filter coefficients according to some examples described in the disclosure.

FIG. 22 illustrates an example training system according to some examples described in the disclosure.

FIG. 23 illustrates a flow diagram of an example process of training and executing a CNN model according to some examples described in the disclosure.

FIGS. 24A and 24B are flow diagrams of example forward and backward-propagation processes in training a CNN model.

FIG. 25 is a flow diagram of an example process of updating the filter coefficients of a CNN model.

FIG. 26 illustrates various embodiments of one or more electronic devices for implementing the various methods and processes described in the disclosure.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

An example of “artificial intelligence logic circuit,” “AI logic circuit,” “AI engine” and “cellular neural network engine” includes a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Examples of “integrated circuit,” “semiconductor chip,” “chip” and “semiconductor device” include integrated circuits (ICs) that contain electronic circuits on semiconductor materials, such as silicon, for performing certain functions. For example, an integrated circuit can be a microprocessor, a memory, a programmable array logic (PAL) device, an application-specific integrated circuit (ASIC), or others. An AI integrated circuit may include an integrated circuit that contains an AI logic circuit.

Examples of “AI chip” include hardware- or software-based device that is capable of performing functions of an AI logic circuit. An AI chip may be a physical IC. For example, a physical AI chip may include an embedded CNN, which may contain weights, filter coefficient, and/or parameters of a CNN model. The embedded CNN may be an example of a CNN processing block in a CNN processing engine. In some examples, an AI chip may have multiple CNN processing engines. An AI chip may also be a virtual chip, i.e., software-based. For example, a virtual AI chip may include one or more processor simulators to implement functions of a desired AI logic circuit.

Examples of “AI model” and “CNN model” include data containing one or more parameters that, when loaded inside an AI chip, are used for executing the AI chip. For example, an AI model for a given CNN may include the filter coefficients such as weights, biases, and other parameters for one or more convolutional layers of the CNN. Here, the filter coefficients, weights and parameters of an AI model are interchangeable.

In some scenarios, the AI chip may contain an AI model for performing certain AI tasks. Executing an AI chip or an AI model may include causing the AI chip (hardware- or software-based) to perform an AI task based on the AI model inside the AI chip and generate an output. Examples of an AI task may include image recognition, voice recognition, object detection, feature extraction, data processing and analyzing, or any recognition, classification, processing tasks that employ artificial intelligence technologies. In some examples, an AI training system may be configured to include a forward propagation neural network, in which information may flow from the input layer to one or more hidden layers of the network to the output layer. An A training system may also be configured to include a backward propagation network to fine tune the weights of the AI model based on the output of the AI chip. An AI model may include a CNN that is trained to perform voice or image recognition tasks. A CNN may include multiple convolutional layers, each of which may include multiple filter coefficients, such as weights and/or other parameters. In such case, an AI model may include parameters of the CNN model.

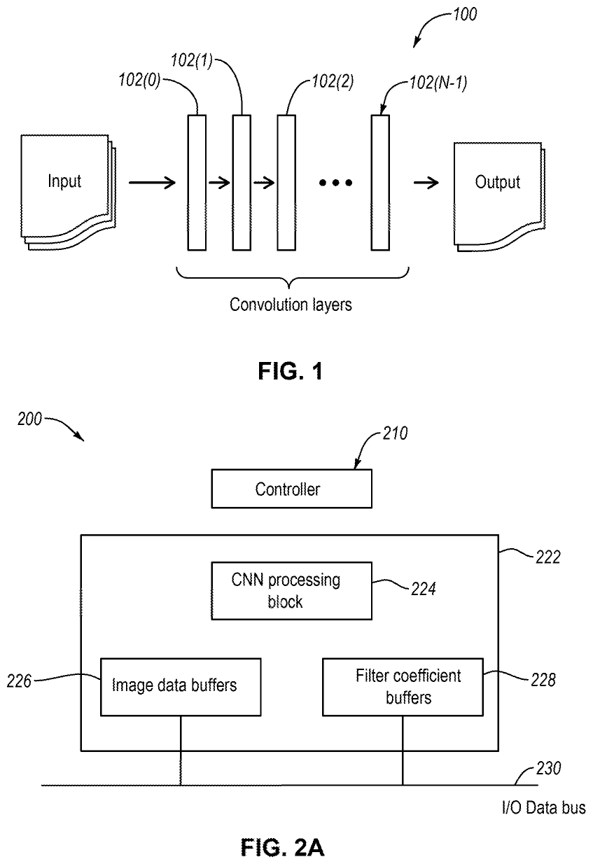

FIG. 1 is a schematic diagram of a portion of an example CNN processing block. An CNN processing block 100 in an AI chip may include multiple convolutional layers, such as 102(0), 102(1), 102(2), . . . 102(N−1). Each of the layers may include multiple filter coefficients, such as weights and/or other parameters. In such case, an AI model may include filter coefficients of the CNN model. In some examples, a CNN model may include weights, such as a kernel and a scalar for a given layer of the CNN model. In some examples, a kernel in a CNN layer may be represented by a mask that has multiple values multiplied by a scalar in higher precision. In some examples, a CNN model may include other filter coefficients. For example, an output channel of a CNN layer may include one or more bias values that, when added to the output of the output channel, adjust the output values to a desired range.

In a non-limiting example, in a CNN model, a computation in a given layer in the CNN may be expressed by y=W*x+b, where x is input data, y is output data in the given layer, W is a kernel/filter, and b is a bias. Operation “*” is an inner product. Kernel W may include binary values. For example, a kernel may include nine cells (filter coefficients) in a 3×3 mask, where each cell may have a binary value, such as “1” or “−1.” In such case, a kernel may be expressed by multiple binary values in the 3×3 mask multiplied by a scalar. The scalar may include a value having a bit width, such as 8-32-bit, for example, 12-bit or 16-bit. Other bit length may also be possible. By multiplying each binary value in the 3×3 mask with the scalar, a kernel may contain values of higher bit-length. Alternatively, and/or additionally, a kernel may contain data with n-value, such as 7-value. The bias b may contain a value having multiple bits, such as 8, 12, 16, 32 bits. Other bit length may also be possible.

In some examples, the CNN model may include any suitable neural network structure, such as VGG16. In VGG16, the CNN model may be a deep neural network having a total of 13 convolution layers. These layers may be implemented in layers 102(0), . . . 102(N−1) in the CNN processing block shown in FIG. 1. These layers may also be grouped into a hierarchical layers, for example, layers 1-1, 1-2; layers 2-1, 2-2; layers 3-1, 3-2, 3-3; layers 4-1, 4-2, 4-3; and layers 5-1, 5-2, 5-3, with a pooling layer between each group of layers. In other words, the CNN processing block in FIG. 1 may have one or more pooling layers arranged in-between some layers.

In some examples, one or more layers of a CNN model may have duplicated weights. For example, layer 102(0) may have duplicated weights from those in layer 102(2). In a VGG16 configuration, layer 5-1 may have the same weights as those in layer 4-1. Similarly, layers 5-2 and 5-3 may have duplicated weights from those in layers 4-2 and 4-3, respectively. As such, the duplicated weights in multiple layers may be stored in a single location as opposed to multiple locations. This results in a saving of memory space in the AI chip. Additionally, and/or alternatively, the saving of the memory space may result in accommodating additional convolution layers in the AI chip, which facilitates a deeper neural network. The CNN processing block 100 may be implemented in various configurations in an AI chip, as will be described in the present disclosure.

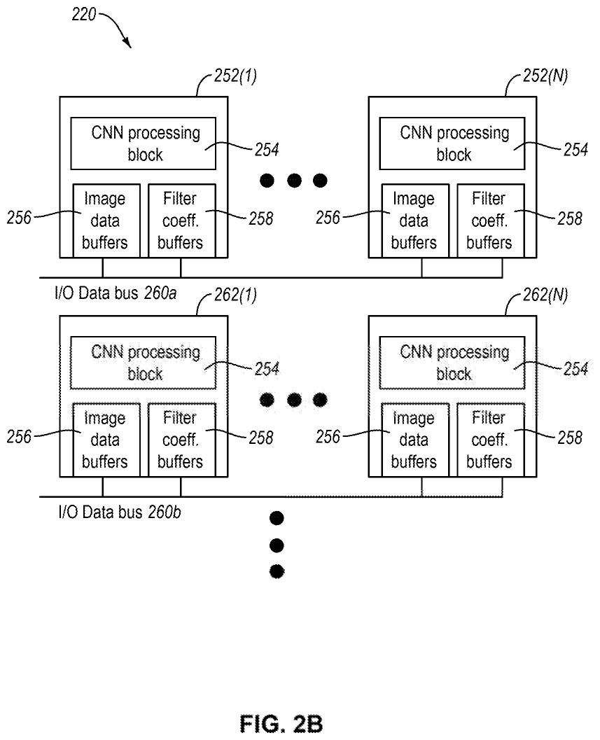

FIG. 2A is a schematic diagram of an AI chip. An example AI chip 200 may include a CNN processing engine controller 210, and a CNN processing engine 222 operatively coupled to at least one input/output (I/O) data bus 230. Controller 210 may be configured to control various operations of the CNN processing engine 222 to perform AI tasks by performing multiple layers of convolutions. For example, when a kernel is a 3×3 mask, the CNN processing engine 222 may include a CNN processing block 224 configured to perform multiple 3×3 convolutions with rectifications or other nonlinear operations (e.g., sigmoid function). The CNN processing engine 222 may also be configured to perform pooling operations. In some examples, performing convolutions may require imagery data in digital form and corresponding filter coefficients, which are supplied to the CNN processing engine 222 via input/output data bus 230. The AI chip may also contain logic gates, multiplexers, register files, memories, state machines, etc.

In a non-limiting example, the CNN processing engine 222 may include a CNN processing block 224, a first set of memory buffers 226 and a second set of memory buffers 228. The first set of memory buffers 226 may be configured for receiving imagery data and for supplying the received imagery data to the CNN processing block 224. The second set of memory buffers 228 is configured for storing filter coefficients and for supplying the received filter coefficients to the CNN processing block 224.

FIG. 2B is a schematic diagram of an AI chip. In some examples, the AI chip 200 may be extendable and scalable. For example, multiple CNN processing engines may be configured into one semiconductor chip 220, where some or all of the CNN processing engines may be identical. In some examples, the number of CNN processing engines in a chip may be any suitable number. For example, the number of CNN processing engine may be 2ⁿ, where n is an integer (e.g., 0, 1, 2, 3, . . . ). In some examples, all of the CNN processing engines are identical. For example, CNN processing engines 252(1)-252(N), 262(i)-262(N) are identical. Each CNN processing engine may be implemented in the CNN processing engine 222 (in FIG. 2A) in some examples. Each CNN processing engine 252(1)-252(N), 262(1)-262(N) may contain a CNN processing block 254, a first set of memory buffers 256 and a second set of memory buffers 258. The first set of memory buffers 256 is configured for receiving imagery data and for supplying the received imagery data to the CNN processing block 254. The second set of memory buffers 258 is configured for storing filter coefficients and for supplying the received filter coefficients to the CNN processing block 254. In general, the number of CNN processing engines on a chip is 2, where n is an integer (i.e., 0, 1, 2, 3, . . . ).

As shown in FIG. 2B, CNN processing engines 252(1)-252(N) are operatively coupled to a first input/output data bus 260a while CNN processing engines 262(1)-262(N) are operatively coupled to a second input/output data bus 260b. Each input/output data bus 260a-260b is configured for independently transmitting and receiving data (e.g., imagery data and filter coefficients). Each of the first and the second sets of buffers are logically defined. In other words, respective sizes of the first and the second sets of buffers can be reconfigured to accommodate respective amounts of imagery data and filter coefficients.

With further reference to FIG. 2B, the first and the second I/O data bus 260a-260b are shown here to couple the CNN processing engines 252(1)-252(N), 262(1)-262(N) in a sequential scheme. In another embodiment, the at least one I/O data bus may have different connection scheme to the CNN processing engines to accomplish the same purpose of parallel data input and output for improving performance. The AI chip 220 may also have multiple input/output data buses. In some examples, while a first CNN processing engine is operably coupled to a first input/output data bus (e.g., 260a), a second CNN processing engine may be operatively coupled to a second input/output data bus (e.g., 260b). Each of the multiple data buses may be configured for independently transmitting and receiving data (i.e., imagery data and filter coefficients). Alternatively, and/or additionally, at least one input/output data bus may be coupled to multiple CNN processing engines and configured to transmit/receive input and output to/from multiple CNN processing engines in parallel. In some examples, the image data buffers 256 and filter coefficient buffers 258 may comprise random access memory (RAM), magnetoresistive random access memory (MRAM), or other types of memory. The CNN processing block, image data buffer and filter coefficient buffer may each be logically defined. Respective sizes of the image data buffers and filter coefficient buffers may be reconfigured to accommodate respective amounts of imagery data and filter coefficients.

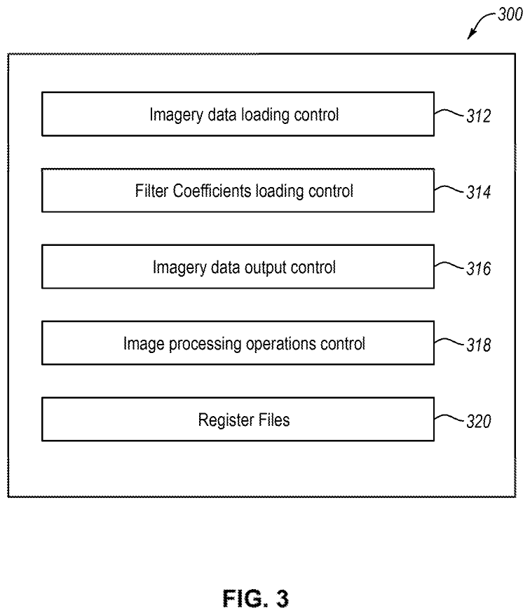

FIG. 3 is a schematic diagram of a controller of a CNN engine. In some examples, the CNN engine may be 222 in FIG. 2A. In FIG. 3, a controller 300 may include imagery data loading control 312, filter coefficients loading control 314, imagery data output control 316, and/or image processing operations control 318. The controller 300 may further include register files 320 for storing the specific configuration (e.g., the number of CNN processing engines, the number of input/output data bus, etc.) in the AI chip. The image data loading control 312 controls loading of imagery data to respective CNN processing engines via the corresponding I/O data bus. Filter coefficients loading control 314 controls loading of the filter coefficients to respective CNN processing engines via corresponding I/O data bus. Imagery data output control 316 controls outputting of the imagery data from respective CNN processing engines via corresponding I/O data bus. Image processing operations control 318 controls various operations such as convolutions, rectifications and pooling operations. In some examples, these operations may be defined by a user of the integrated circuit via a set of user defined directives (e.g., file contains a series of operations such as convolution, rectification, pooling, etc.).

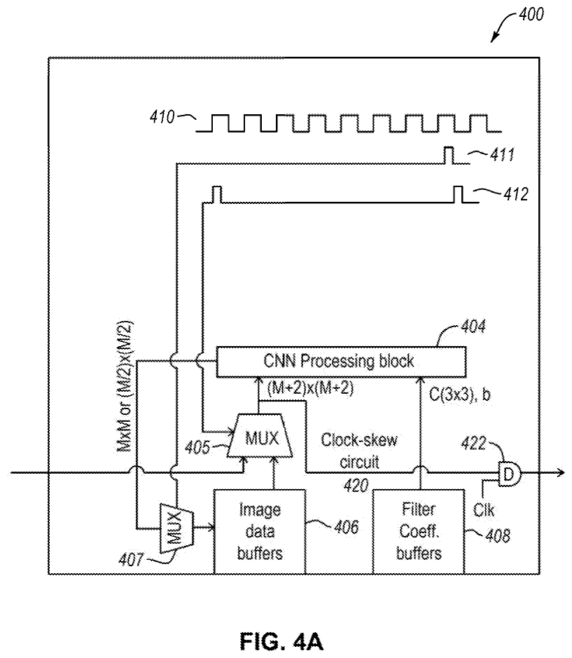

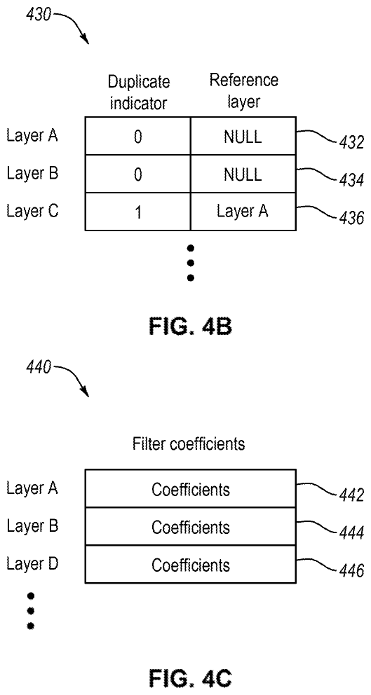

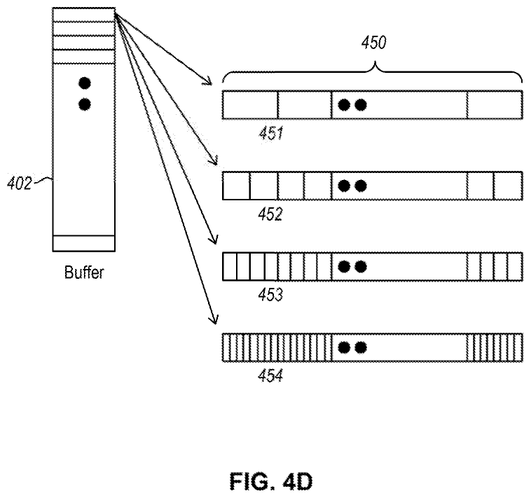

FIG. 4A is a schematic diagram showing more details of an example CNN processing engine 400. In some examples, the CNN processing engine 400 may be implemented in 222 (in FIG. 2A), 252(1)-(N), 262(1)-(N)(in FIG. 2B). A kernel of CNN convolutions may have a size of 3×3. In such case, a CNN processing engine 400 may have a CNN processing block 404 that may be configured to simultaneously obtain M×M convolution operations results by performing convolutions (e.g., 3×3 convolutions) at M×M pixel locations using imagery data of a (M+2)-pixel by (M+2)-pixel region and corresponding filter coefficients from the respective memory buffers. The (M+2)-pixel by (M+2)-pixel region is formed with the M×M pixel locations as an M-pixel by M-pixel central portion plus a one-pixel border surrounding the central portion. M is a positive integer. (M+2)-pixel is used to accommodate the 3×3 kernel. If the size of the kernel vary, the (M+2)-pixel may change accordingly. In a non-limiting example, M has a value of 14, and therefore, (M+2)=16, M×M equals 414=196, and M/2 equals 7. In some examples, in performing the convolutions in the CNN engine, the CNN filter coefficients may be accessed sequentially from a memory buffer location for a given convolution layer. Duplicate weights in one or more convolution layers may be accessed via a link to the original weights. This is further explained with reference to FIGS. 4B and 4C.

FIGS. 4B and 4C are example memory blocks in a CNN processing engine. In the example in FIG. 4B, a memory block 430 may contain an index table that includes locations of duplicate weights of the CNN processing engine. For example, the memory block 430 may include, for each convolution layer, a duplicate indicator and a reference layer index, which points to a location of duplicate weights. In some examples, the duplicator indicator may have a binary value, such as 0 (False) and 1 (True), where 0 (False) indicates that the layer does not have duplicated weights from another layer. Conversely, a layer having duplicate indicator value of 1 (True) has its weights duplicated from another layer. In such case, a reference layer value for that layer may contain an memory location (e.g., memory address) of the weights of the reference layer. In the example in FIG. 4B, layers A and B both have their own weights, while the weights of layer C are duplicated from the reference layer: layer A. In some examples, the values of the duplicate indicator may be defined and preset in the memory. In other words, which convolution layer duplicates which layer's weights or which layer does not duplicate other layers' weights may be determined in the design of the CNN processing engine.

FIG. 4C shows an example memory block 440 containing filter coefficients of multiple convolution layers of a CNN processing block. The memory block 440 may reside in the filter coefficient buffer, e.g., 228 (in FIG. 2), 258 (in FIG. 2B), 408 (in FIG. 4A). In FIG. 4C, at the first location 442, the memory block 440 contains filter coefficients for layer A. The memory block 440 may sequentially store the filter coefficients for layer B at the next memory block 444. Layer C contains duplicated weights from layer A, as such, the memory block 440 does not need to store duplicated weights for layer C. Instead, the memory block 440 subsequently stores the weights for layer D at location 446. In some examples, the memory blocks for different convolution layers may have different configurations. For example, various memory blocks for containing filter coefficients may have different sizes. Similarly, various filter coefficient buffers in various CNN processing blocks may also have different sizes and storage schemes.

FIG. 4D illustrates example storage schemes of filter coefficients. A filter coefficient buffer (e.g., buffer 402) has a width (i.e., word size 450). In one embodiment, the word size is 120-bit. Accordingly, each of the filter coefficients (e.g., C(3×3) and b) occupies 12-bit in the first example storage scheme 451. In the second example storage scheme 452, each filter coefficient occupies 6-bit thereby 20 coefficients are stored in each word. In the third example scheme 453, 3-bit is used for each coefficient hence four sets of filter coefficients (40 coefficients) are stored. In the fourth example storage scheme 454, 80 coefficients are stored in each word, each coefficient occupies 1.5-bit.

Alternatively, and/or additionally, a third memory buffer may be configured to store the entire filter coefficients to avoid I/O delay. The input image may be at certain size such that all filter coefficients can be stored. This can be done by allocating some unused capacity in the first memory buffer (e.g., image data buffer 226 in FIG. 2) or the second memory buffer (e.g., filter coefficient buffer 228 in FIG. 2) to accommodate such a third memory buffer. Since all memory buffers are logically defined (e.g., in RAM), existing techniques may be used for creating the third memory buffer. For example, the first and the second sets of memory buffers can be adjusted to fit different amounts of imagery data and/or filter coefficients. Furthermore, the total amount of memory space is dependent upon what is required in image processing operations.

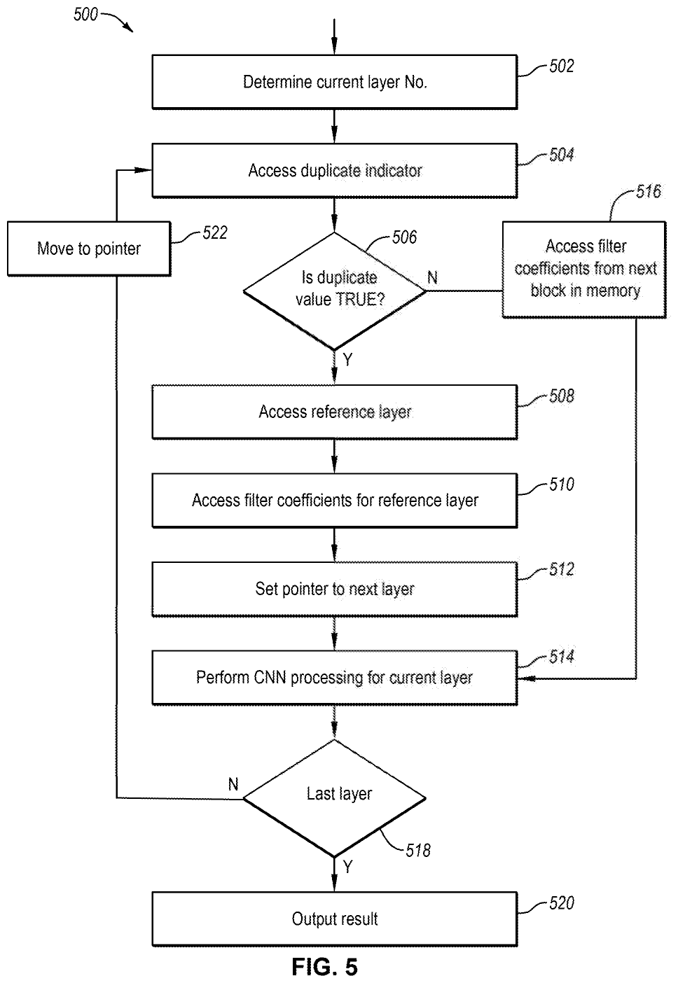

FIG. 5 is a flow diagram of an example process 500 of performing CNN convolution operations that may be implemented in a CNN processing engine. In some examples, the process 500 may be implemented in a controller, such as controller 210 (in FIG. 2). The controller may be programmed to perform one or more operations as described in FIG. 5. The process 500 may access filter coefficients for multiple layers of a CNN processing block in one or more iterations. In some examples, the process 500 may determine the current layer number at operation 502. For example, the process may determine the memory location for layer A (e.g., 432 in FIG. 4B). The process 500 may access duplicate indicator value at 504 from the memory location for layer A, and determine whether the duplicate indicator value contained in the duplicate indicator is True at 506. If the duplicate indicator is False, it means that the filter coefficients for that current layer are stored at a memory location for that layer. Thus, the process 500 may access filter coefficient for the current layer from the next memory block at operation 516. In the example in FIG. 4C, the process 500 may access the filter coefficients for layer A at memory location 442.

With further reference to FIG. 5, if the duplicate indicator is True, the process may access the memory location of the reference layer at 508, and access filter coefficients for the reference layer at 510. In the example in FIGS. 4B and 4C, the duplicate indicator value for layer C at memory location 436 is True and the reference layer is layer A. Thus, the process may access the location of layer A at 442 (in FIG. 4C) and access the duplicate filter coefficients at that memory location. Once the duplicated weights are accessed, the process 500 may set the pointer to the memory location of the next layer at 512 and move to the pointer at 522 in the next iteration. In other words, if accessing duplicated weights is considered getting out of sequence in memory accessing (for different layers), then setting the pointer to the next layer at 512 is considered getting back to the memory block sequence. For example, in FIG. 4C, the pointer for memory access was at 444 for layer B. When accessing weights for layer C, the process may get out of the sequence and jump to the memory location 442 to access duplicated weights in layer A. After accessing the duplicated weights in layer A, the process may set the pointer to memory location 446 back to the memory location sequence in FIG. 4C. The process 500 may repeat operations 504, 506, 514, 518, 522, and or other operations (e.g., 508, 510, 512, or 516) in one or more iterations until all of the convolution layers in the CNN processing block have been processed.

Now, after accessing the filter coefficients (either from the next memory location in sequence at 516 or from the reference layer at 510), the process may perform CNN processing (e.g., performing convolution operations) for the current layer using the accessed filter coefficients at 514. The process 500 may continue for multiple convolution layers of the CNN engine in one or more iterations until the operation for the last layer at 518 is completed. Then, the process may output the convolution result at 520.

Other configurations of memory blocks for containing and accessing filter coefficients may also be possible. For example, one or more operations in the process 500 may be implemented in a circuitry in a controller (e.g., 210 in FIG. 2). In an example configuration, the CNN engine may include a fuse array to pre-set the duplicate indicator values for each convolution layer. The CNN processing engine may also include one or more registers to store the duplicate indicator values for one or more convolution layers. A control circuit may be configured to select a memory address responsive to a layer selection signal. For example, the control circuit may include a multiplexer having inputs coupled to a fuse array that sets the duplicate indicator value for each convolution layer. The layer selection signal may be coupled to the control terminal of the multiplexer. When a layer selection signal is applied to the multiplexer, the multiplexer may select one of the duplicate indicator values from the fuse array to the output of the multiplexer, where the output signal activates a corresponding register that stores the corresponding memory location of the weights for the selected convolution layer. In the example in FIGS. 4B and 4C, the duplicate indicator values may be stored in a fuse array. The memory location of reference layers may be stored in respective registers and selected by the control circuit responsive to the layer selection signal.

In some examples, filter coefficients may be stored in memory buffers, such as filter coefficient buffers 228 (in FIG. 2A), 258 (in FIG. 2B), 408 (in FIG. 4A). For example, filter coefficients may include multiple subsets each for an associated CNN processing engine. The filter coefficient buffers associated with a CNN processing block (e.g., 228 in FIG. 2A, 258 in FIG. 2B, 408 in FIG. 4A) may store one or more subsets of the multiple subsets of filter coefficients to be fed into the CNN processing block. One of the filter coefficient buffers may store the filter coefficients for a first convolution layer of the CNN processing block and another filter coefficient buffer may store the filter coefficients for a second convolution layer of the CNN processing block. In some examples, the first and second convolution layers of the CNN processing block may include duplicate weights/filter coefficients. In such case, one of the filter coefficient buffers may store actual coefficients, while another filter coefficient buffer stores a location information about the filter coefficient buffer that contains the actual filter coefficients. For example, the filter coefficients of convolutions layers A and K are duplicate. A first filter coefficient buffer may store the actual coefficients for convolution layer A, and a second filter coefficient buffer may store the reference location of the first filter coefficient buffer rather than the filter coefficients for the convolution layer K themselves. This results in a saving of the memory space in the CNN processing engine.

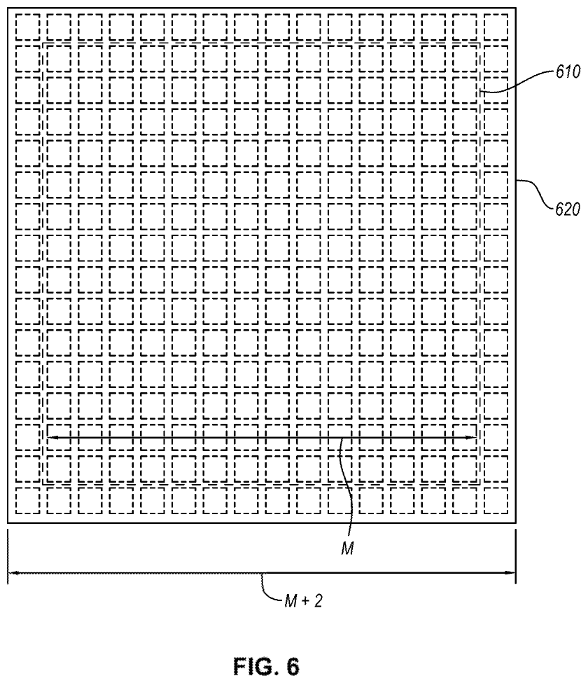

FIG. 6 is a diagram showing a diagram representing (M+2)-pixel by (M+2)-pixel region 610 with a central portion of M×M pixel locations 620 used in a CNN processing engine, such as 222 (in FIG. 2A), 252, 262 (in FIG. 2B), 400 (in FIG. 4A). Imagery data may represent characteristics of a pixel in the input image such as, color values of the pixel (e.g., red, green, blue (RGB), or the distance between pixel and observing location. In some examples, the value of the RGB is an integer between 0 and 255. The values of filter coefficients may be floating point integer numbers that can be either positive or negative. Alternatively, and/or additionally, the values of filter coefficients may be fixed point. In order to achieve faster computations, few computational performance improvement techniques may be used and implemented in a CNN processing block, e.g., 404 in FIG. 4A. In some examples, imagery data may be represented by as few bits as practical (e.g., 5-bit representation). Each filter coefficient may be represented as an integer with a radix point. Similarly, the filter coefficient may represented by an integer and use as few bits as practical. As a result, convolutions can then be performed using fixed-point arithmetic for faster computations.

In some examples, a 3×3 convolution may produce one convolution operation output, Out(m, n), based on the following formula:

Out(m,n)=Σ_{1≤i,j≤3}In(m,n,i,j)×C(i,j)−b (1)

where m, n are corresponding row and column numbers for identifying which imagery data (pixel) within the (M+2)-pixel by (M+2)-pixel region the convolution is performed; In(m, n, i, j) is a 3-pixel by 3-pixel area centered at pixel location (m, n) within the region; ((i,j) represents one of the weight coefficients in a mask, such as 9 coefficients in a C(3×3) mask, each corresponding to one of the 3-pixel by 3-pixel area; b represents an offset coefficient, such as a bias; and j is the index of weight coefficients in C(i,j).

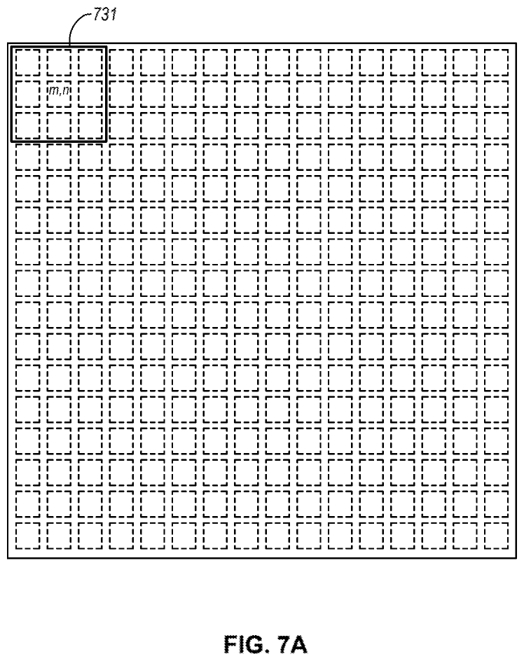

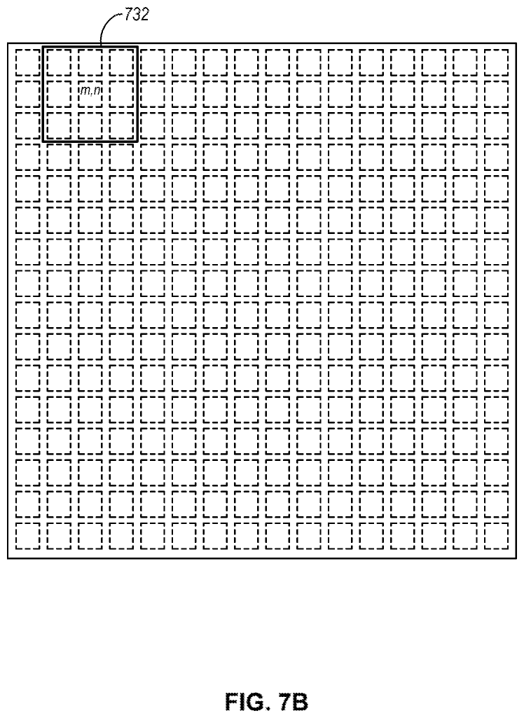

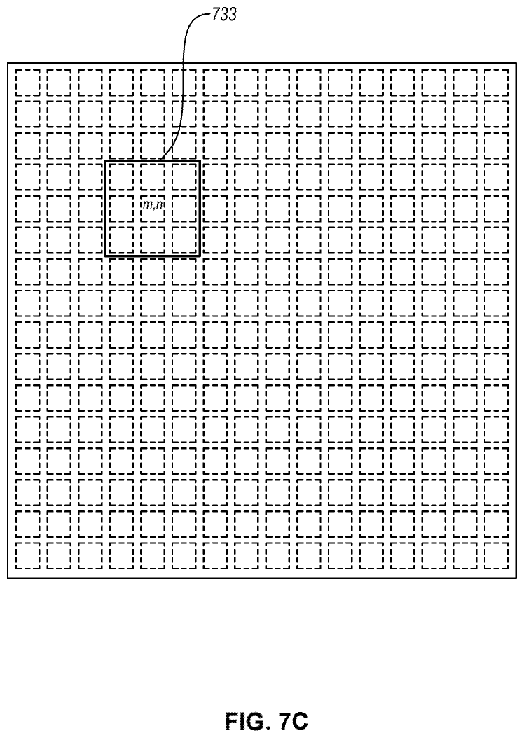

Each CNN processing block, e.g., 204 (in FIG. 2A), 254 (in FIG. 2B), 404 (in FIG. 4A), performs M×M convolution operations simultaneously in multiple CNN processing engines. These operations are further described in FIGS. 7-21.

FIGS. 7A-7C show three different examples of the M×M pixel locations. The first pixel location 731 shown in FIG. 7A is in the center of a 3-pixel by 3-pixel area within the (M+2)-pixel by (M+2)-pixel region at the upper left corner. The second pixel location 732 shown in FIG. 7B is one pixel data shift to the right of the first pixel location 731. The third pixel location 733 shown in FIG. 7C is a typical example pixel location. M×M pixel locations may contain multiple overlapping 3-pixel by 3-pixel areas within the (M+2)-pixel by (M+2)-pixel region.

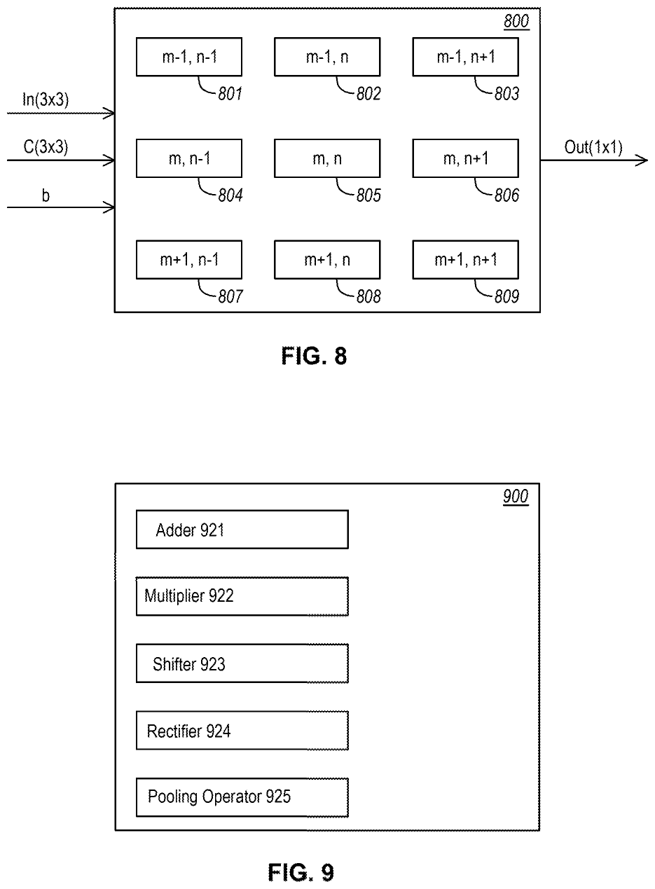

FIG. 8 is a diagram illustrating an example data arrangement for performing convolutions at a pixel location according to some examples described in the disclosure. As shown, in some examples, to perform 3×3 convolutions at each sampling location, an example data arrangement is shown in FIG. 8. Imagery data (i.e., In(3×3)) and filter coefficients (e.g., weight coefficients C(3×3) and an offset coefficient b) are fed into an example CNN 3×3 circuitry 800. After 3×3 convolution operations in accordance with Formula (1) are performed, one output result (i.e., Out(1×1)) is produced. At each sampling location, the imagery data In(3×3) is centered at pixel coordinates (m, n) 805 with eight immediate neighbor pixels 801-804, 806-809.

FIG. 9 is a function diagram showing an example circuitry for performing convolutions at each pixel location. For example, the circuitry 900 may be used to perform the 3×3 convolutions as shown in FIG. 8. In some examples, the circuitry 900 may include an adder 921, a multiplier 922, a shifter 923, a rectifier 924 and/or a pooling operator 925. In a digital semi-conductor implementation, all of these can be achieved with logic gates and multiplexers (e.g., hardware description language such as Verilog, etc.). Adder 921 and multiplier 922 may perform addition and multiplication operations. Shifter 923 may be configured to shift the output result in accordance with fixed-point arithmetic involved in the convolutions. Rectifier 924 may be configured to set negative output results to zero. Pooling operator 925 may be configured to perform pooling operations, e.g., 2×3 pooling.

Returning to FIG. 4A, convolution operations of a CNN processing engine are now further explained. In some examples, imagery data are stored in a first set of memory buffers 406, while filter coefficients are stored in a second set of memory buffers 408. Both imagery data and filter coefficients are fed to the CNN block 404 at each clock of the digital integrated circuit. Filter coefficients (e.g., C(3×3) and b) are fed into the CNN processing block 404 directly from the second set of memory buffers 408. However, imagery data are fed into the CNN processing block 404 via a multiplexer 405 from the first set of memory buffers 406. Multiplexer 405 selects imagery data from the first set of memory buffers based on a clock signal (e.g., pulse 412). Otherwise, multiplexer 405 selects imagery data from a first neighbor CNN processing engine (from the left side of FIG. 4A) through a clock-skew circuit 420. At the same time, a copy of the imagery data fed into the CNN processing block 404 is sent to a second neighbor CNN processing engine (to the right side of FIG. 4A) via the clock-skew circuit 420. Clock-skew circuit 420 may be achieved with known techniques (e.g., a D flip-flop 422).

The first neighbor CNN processing engine may be referred to as an upstream neighbor CNN processing engine in the loop circuit formed by the clock-skew circuit 420. The second neighbor CNN processing engine may be referred to as a downstream CNN processing engine. In another embodiment, when the data flow direction of the clock-skew circuit is reversed, the first and the second CNN processing engines are also reversed and become downstream and upstream neighbors, respectively. In some examples, after 3×3 convolutions for each group of imagery data are performed for predefined number of filter coefficients, convolution operations results Out(m, n) are sent to the first set of memory buffers via another multiplex MUX 407 based on another clock signal (e.g., pulse 411). An example clock cycle 410 is drawn for demonstrating the time relationship between pulse 411 and pulse 412. As shown pulse 411 is one clock before pulse 412, as a result, the 3×3 convolution operation results are stored into the first set of memory buffers after a particular block of imagery data has been processed by all CNN processing engines through the clock-skew circuit 420.

After the convolution operations result Out(m, n) is obtained from Formula (1), rectification procedure may be performed as directed by image processing control, e.g., 318 in FIG. 3. In some examples, any convolution operations result, Out(m, n), less than zero (i.e., negative value) is set to zero. In other words, only positive value of output results are kept.

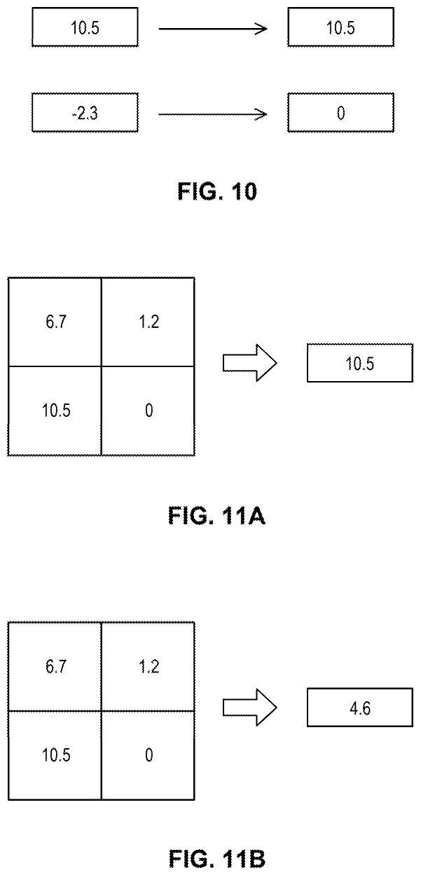

FIG. 10 shows two example outcomes of rectification. A positive output value 10.5 retains as 10.5 while −2.3 becomes 0. Rectification causes non-linearity in the integrated circuits. If a 2×2 pooling operation is required, the M×M output results are reduced to (M/2)×(M/2). In order to store the (M/2)×(M/2) output results in corresponding locations in the first set of memory buffers, additional bookkeeping techniques are required to track proper memory addresses such that four (M/2)×(M/2) output results can be processed in one CNN processing engine.

To demonstrate a 2×2 pooling operation, FIG. 11A is a diagram graphically showing first example output results of a 2-pixel by 2-pixel block being reduced to a single value 10.5, which is the largest value of the four output results. The technique shown in FIG. 11A is referred to as “max pooling”. When the average value 4.6 of the four output results is used for the single value shown in FIG. 11B, it is referred to as “average pooling”. There are other pooling operations, for example, “mixed max average pooling” which is a combination of“max pooling” and “average pooling”. The main goal of the pooling operation is to reduce size of the imagery data being processed.

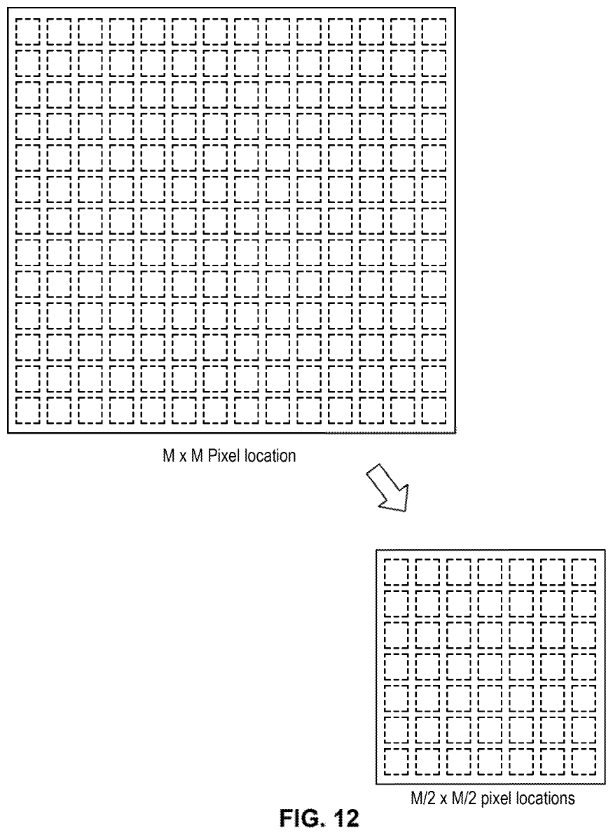

FIG. 12 is a diagram illustrating M×M pixel locations, through a 2×2 pooling operation, are reduced to (M/2)×(M/2) locations, which is one fourth of the original size.

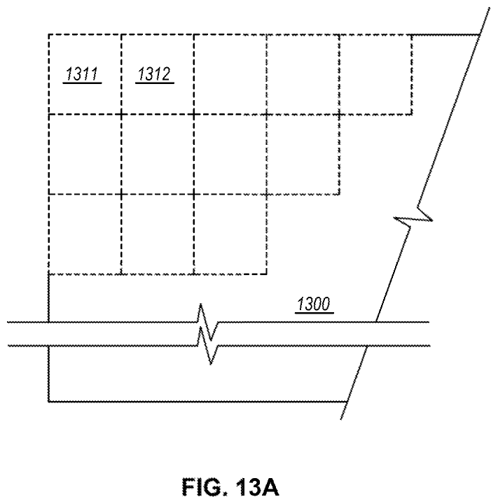

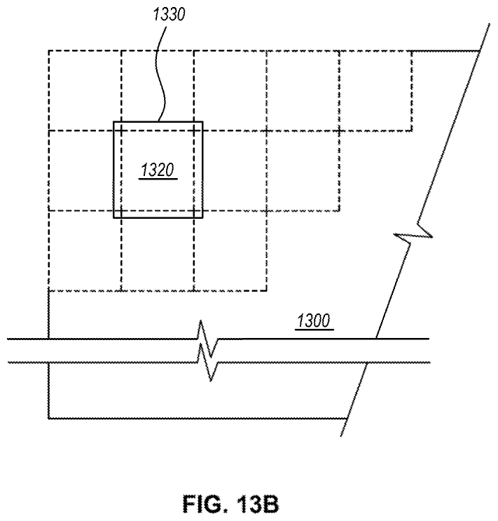

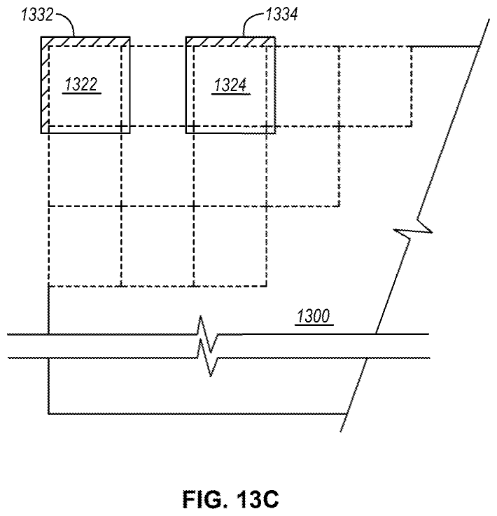

An input image generally contains a large amount of imagery data. FIG. 13A shows an example of image partition in order to perform image processing operations. In some examples, the input image 1300 is partitioned into M-pixel by M-pixel blocks 1311-1312 as shown in FIG. 13A. Imagery data associated with each of these M-pixel by M-pixel blocks is then fed into respective CNN processing engines. At each of the M×M pixel locations in a particular M-pixel by M-pixel block, 3×3 convolutions are simultaneously performed in the corresponding CNN processing block.

Although the CNN processing engine (e.g., 402 in FIG. 4A) does not require specific characteristic dimension of an input image, the CNN processing engine may resize the input image, such as reducing to fit to a predefined characteristic dimension for certain image processing procedures. In an embodiment, a square shape with (2^{K}×M)-pixel by (2^{K}×M)-pixel is required. K is a positive integer (e.g., 1, 2, 3, 4, etc.). When M equals 14 and K equals 4, the characteristic dimension is 224. In another embodiment, the input image is a rectangular shape with dimensions of (2^{I}×M)-pixel and (2^{J}×M)-pixel, where I and J are positive integers.

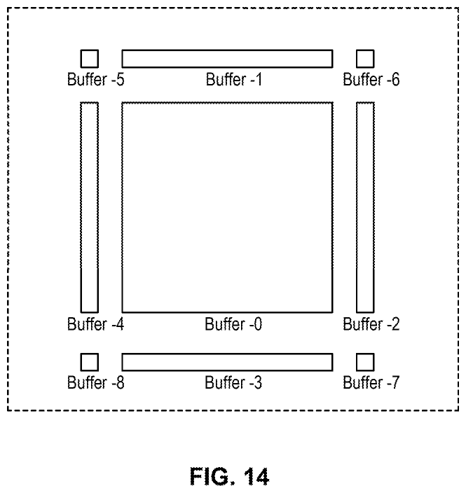

In order to properly perform 3×3 convolutions at pixel locations around the border of a M-pixel by M-pixel block, additional imagery data from neighboring blocks are required. FIG. 13B shows a typical M-pixel by M-pixel block 1320 (bordered with dotted lines) within a (M+2)-pixel by (M+2)-pixel region 1330. The (M+2)-pixel by (M+2)-pixel region is formed by a central portion of M-pixel by M-pixel from the current block, and four edges (i.e., top, right, bottom and left) and four corners (i.e., top-left, top-right, bottom-right and bottom-left) from corresponding neighboring blocks. Additional details are shown in FIG. 14 and corresponding descriptions for the first set of memory buffers.

Now, FIG. 13C shows two example M-pixel by M-pixel blocks 1322-1324 and respective associated (M+2)-pixel by (M+2)-pixel regions 1332-1334. These two example blocks 1322-1324 are located along the perimeter of the input image. The first example M-pixel by M-pixel block 1322 is located at top-left corner, therefore, the first example block 1322 has neighbors for two edges and one corner. Value “0”s are used for the two edges and three corners without neighbors (shown as shaded area) in the associated (M+2)-pixel by (M+2)-pixel region 1332 for forming imagery data. Similarly, the associated (M+2)-pixel by (M+2)-pixel region 1334 of the second example block 1324 requires “0” s be used for the top edge and two top corners. Other blocks along the perimeter of the input image are treated similarly. In other words, for the purpose to perform 3×3 convolutions at each pixel of the input image, a layer of zeros (“0”s) is added outside of the perimeter of the input image. Other methods may also be used. For example, default values of the first set of memory buffers may be set to zero. If no imagery data is filled in from the neighboring blocks, those edges and corners would contain zeros.

In some scenarios, an input image may contain a large amount of imagery data, which may not be able to be fed into the CNN processing engines in its entirety. Therefore, the first set of memory buffers may be configured on the respective CNN processing engines for storing a portion of the imagery data of the input image. In some examples, the first set of memory buffers may contain nine different data buffers, as illustrated in FIG. 14. In this example, the nine buffers are designed to match the (M+2)-pixel by (M+2)-pixel region as follows:

1) buffer-0 for storing M×M pixels of imagery data representing the central portion;
2) buffer-1 for storing 1×M pixels of imagery data representing the top edge;
3) buffer-2 for storing M×1 pixels of imagery data representing the right edge;
4) buffer-3 for storing 1×M pixels of imagery data representing the bottom edge;
5) buffer-4 for storing M×1 pixels of imagery data representing the left edge;
6) buffer-5 for storing 1×1 pixels of imagery data representing the top left corner;
7) buffer-6 for storing 1×1 pixels of imagery data representing the top right corner;
8) buffer-7 for storing 1×1 pixels of imagery data representing the bottom right corner; and
9) buffer-8 for storing 1×1 pixels of imagery data representing the bottom left corner.

In some examples, imagery data received from the I/O data bus may be arranged in the form of M×M pixels of imagery data in consecutive blocks. Each M×M pixels of imagery data is stored into buffer-0 of the current block. The left column of the received M×M pixels of imagery data is stored into buffer-2 of previous block, while the right column of the received M×M pixels of imagery data is stored into buffer-4 of next block. The top and the bottom rows and four corners of the received M×M pixels of imagery data are stored into respective buffers of corresponding blocks based on the geometry of the input image (e.g., FIGS. 13A-13C).

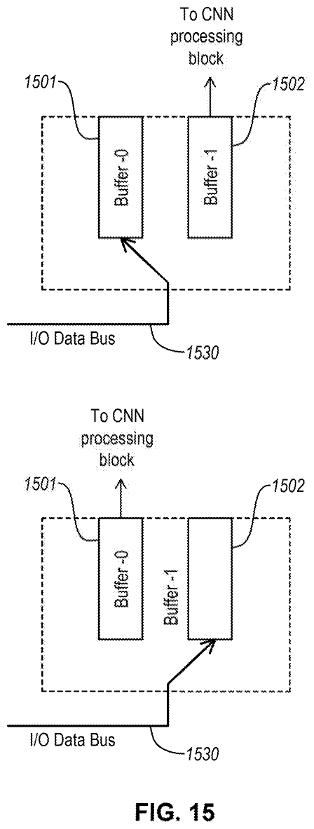

FIG. 15 shows an example of second set of memory buffers for storing filter coefficients. In some embodiments, a pair of independent buffers Buffer0 1501 and Buffer1 1502 are provided. Each of the buffers in the pair of buffers may be configured in the example in FIG. 4D. The pair of independent buffers allow one of the buffers 1501-1502 to receive data from the I/O data bus 1530 while the other one to feed data into a CNN processing block. Two operational modes are shown herein.

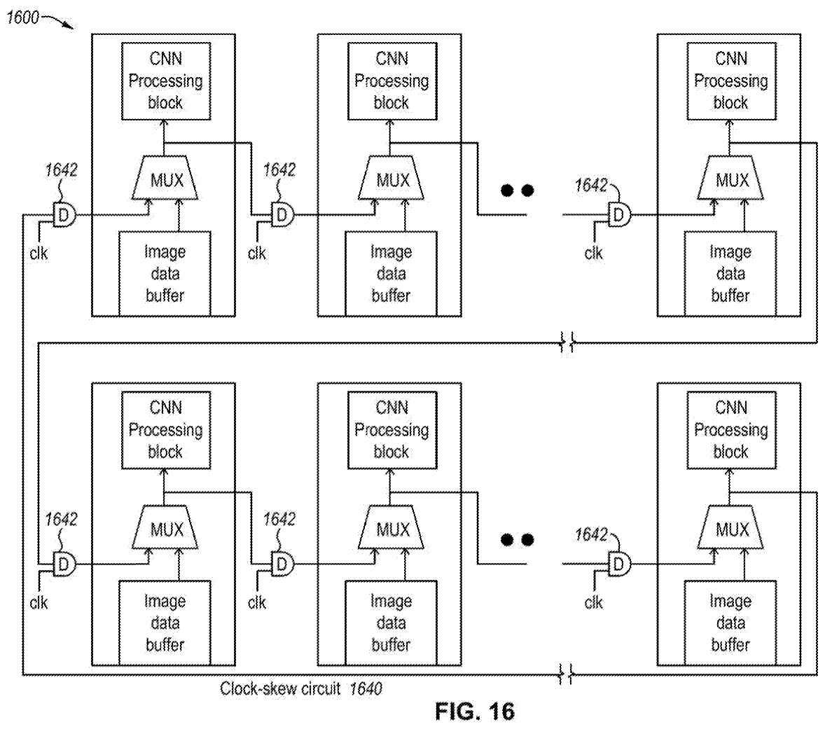

FIG. 16 is a schematic diagram showing a plurality of CNN processing engines implemented in a semiconductor chip (e.g., an AI chip) for performing CNN convolution operations. In some examples, the CNN operations in an AI chip, e.g., 1600, may be performed with one or more convolution layers in one or more CNN processing engines having duplicate weights from other convolution layers. Similar memory storage schemes in storing and accessing duplicate weights, such as those described in FIGS. 48-4D, may be used.

In FIG. 16, a CNN processing engine of the plurality of CNN processing engines may be coupled to first and second neighbor CNN processing engines via a clock-skew circuit. For illustration simplicity, only CNN processing block and memory buffers for imagery data are shown. In some examples, a clock-skew circuit 1640 for a group of CNN processing engines are shown in FIG. 16. The CNN processing engines may be coupled via the clock-skew circuit 1640 to form a loop circuit. In some examples, clock-skew circuit 1640 may be configured to control each of the CNN processing engines to receive and send data in a cyclic manner. For example, the clock-skew circuit 1640 may include multiple D flip-flops 1642, each coupled to a respective CNN processing engine. In such configuration, a CNN processing engine may be configured to send its own imagery data to a first neighbor and, at the same time, receive imagery data from a second neighbor. In a special case, two CNN processing engines are coupled in a loop, in which the first neighbor and the second neighbor are the same.

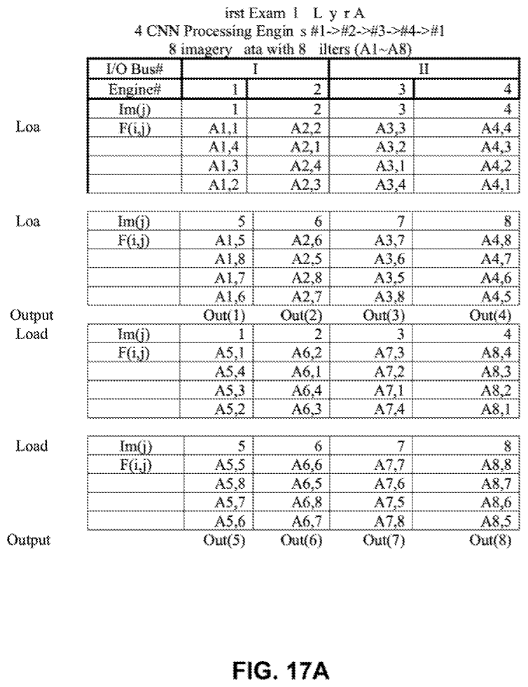

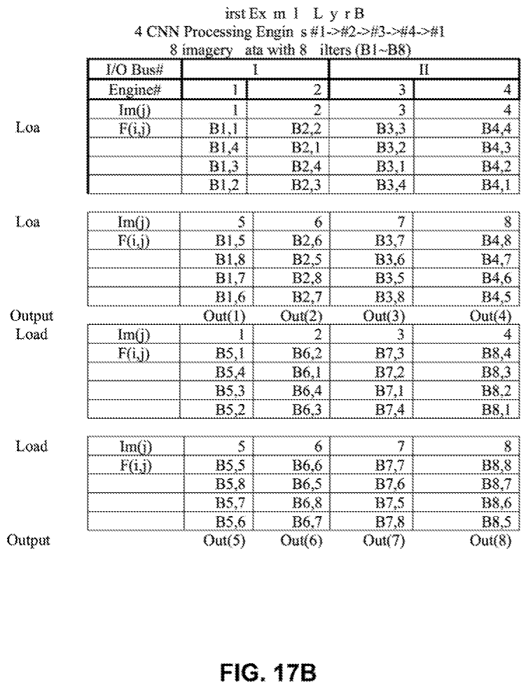

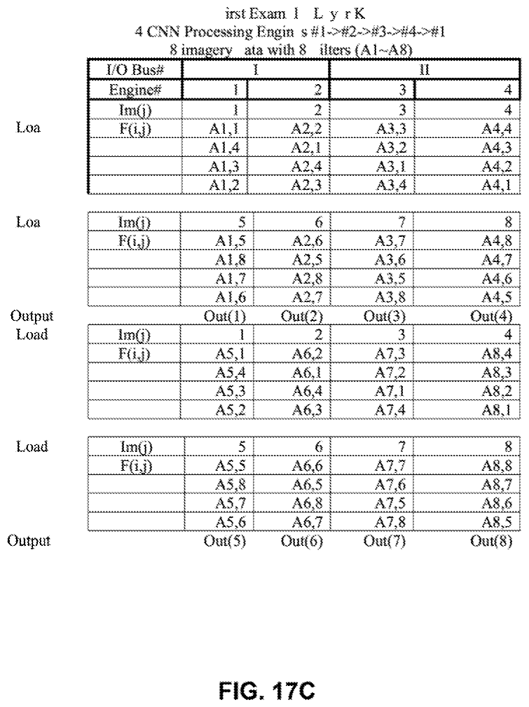

FIGS. 17A-17C are example data patterns of imagery data and filter coefficients for performing CNN operations over various layers using multiple CNN processing engines. Referring now to FIG. 17A, it shows an example order of convolution operations performed in a first example CNN based digital IC for performing AI tasks by extracting image features out of input images. The example CNN based digital IC contains four CNN processing engines connected with a clock-skew circuit (e.g., clock-skew circuit 1640 of FIG. 16) and two I/O/data bus. The I/O data bus #1 serves CNN processing engines 1 and 2, while the I/O data bus #II serves CNN processing engines 3 and 4. The direction of the data access in the clock-skew circuit is Engine #1→Engine #2→Engine #3→Engine #4→Engine #1. In the first example, the upstream neighbor CNN processing engine for CNN processing engine #1 is CNN processing engine #4.

In the example in FIG. 17A, eight sets of imagery data with 8 filters for convolution layer A are used. Eight sets of imagery data are divided into two imagery data groups with each imagery data group containing 4 sets of imagery data. Filter coefficients of 8 filters are divided into two filter groups each filter groups containing 4 sets of filter coefficients. Each filter group is further divided into two subgroups corresponding to two imagery data groups. Each subgroup contains a portion of the 4 sets of filter coefficients correlating to a corresponding one of the two imagery data groups.

The order of the convolution operations for each block of the input image (e.g., block 1311 of the input image 1300 of FIG. 13A) starts with a first imagery data group of imagery data (i.e., Im(1), Im(2), Im(3) and Im(4)) being loaded (load-1) to respective CNN processing engines (i.e., Engines #1-4). To perform the convolution operations in cyclic manner (with reference to the clock-skew circuit 1640 in FIG. 16), filter coefficients of the first portion of the first filter group for convolution layer A (e.g., F(i,j) for filters A1-A4 correlating to Im(1)-Im(4)) are loaded. The order of the first portion is decided by cyclic access of imagery data from an upstream neighbor CNN processing engine. After four rounds of convolution operations, a second imagery data group (i.e., Im(5), Im(6), Im(7) and Im(8)) is loaded (load-2). Filter coefficient of a second portion of the first filter group for convolution layer A (e.g., F(i,j) for filters A1-A4 correlating to Im(5)-Im(8)) are loaded and used. After four rounds of convolution operations, the convolution operations results for filters A1-A4 are outputted (Out(1)-A˜Out(4)-A) and stored into a designated area of the first set of memory buffers of respective CNN processing engines.

The convolution operations may continue for remaining filter groups. The first imagery data group (i.e., Im(1)-Im(4)) is loaded (load-3) again into respective CNN processing engines. Filter coefficients of the first portion of the second filter group for convolution layer A (e.g., F(i,j) for filters A5-A8 correlating to Im(1)-Im(4)) are loaded. Four rounds of convolution operations are performed. The second imagery data group (i.e., Im(5)-Im(8)) is loaded (load-4). Filter coefficients of the second portion of the second filter group for convolution layer A (e.g., F(i,j) for filters A5-A8 correlating to Im(5)-Im(8)) are loaded for four more rounds of convolution operations. Convolution operations results for filters A5-A8 are then outputted (output-1, which includes Out(5)-A˜Out(8)-A).

FIG. 17B shows the convolution operations in a cyclic manner (with reference to the clock-skew circuit 1640 in FIG. 16), as similarly described with respect to FIG. 17A. Instead of loading the filters for convolution layer A, the filters B1-B8 for convolution layer B are loaded in a cyclic manner. Convolution operations results for filters B1-B8 are then outputted (output-2, which includes Out(1)-B˜Out(8)-B) in a similar manner as described with respect to FIG. 17A.

FIG. 17C shows the convolution operations in a cyclic manner based on the connectivity of the clock-skew circuit (e.g., clock-skew circuit 1640 of FIG. 16), as similarly described with respect to FIGS. 17A and 17B. In this example, the weights of convolution layer K are duplicated from the weights in convolution layer A. As such, the filters for convolution layer A are loaded in a cyclic manner for convolution operations in convolution layer K, similar to the manner in which the filters for convolution layer A are loaded for operations in convolution layer A. Convolution operations results for filters A1-A8 are then outputted (Out(1)-K˜Out(8)-K) in a similar manner as described with respect to FIGS. 17A and 17B.

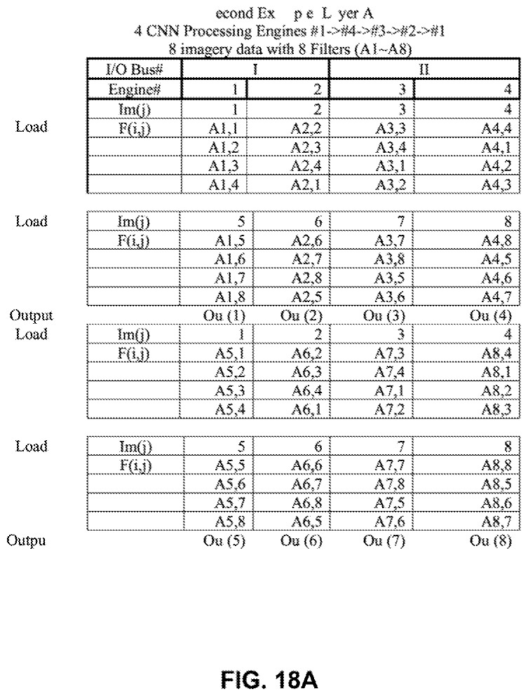

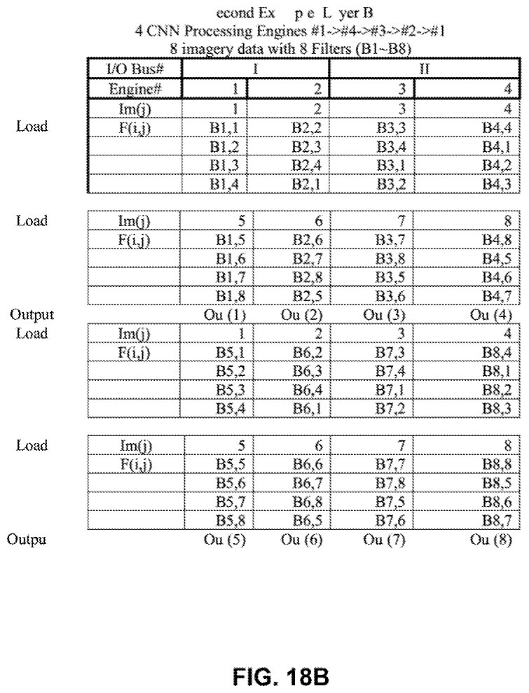

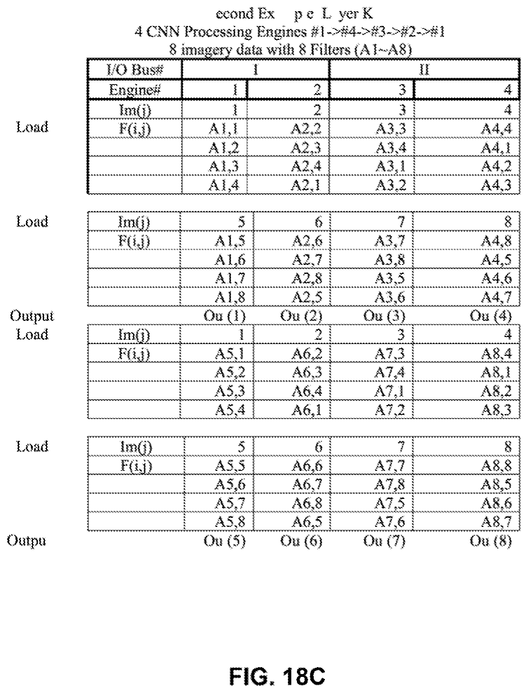

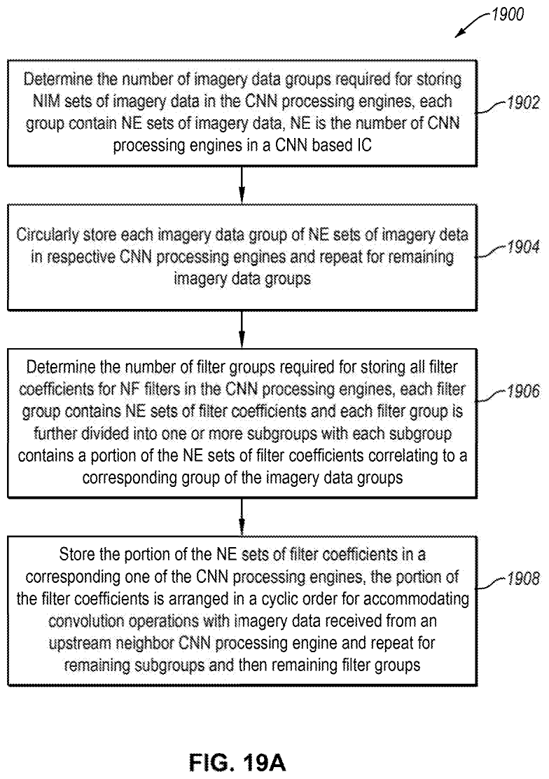

The order of convolution operations of a second example CNN based digital IC is shown in FIGS. 18A-18C. The second example IC is the same as the first example IC except the direction of data access in the clock-skew circuit is reversed (i.e., Engine #1→Engine #4→Engine #3→Engine #2→Engine #1). In other words, the upstream neighbor CNN processing engine for CNN processing engine #1 is CNN processing engine #2. As a result, the order of filter coefficients are different. However, the final convolution operations results are the same.

There can be other connection schemes to form a loop. Similar to the two examples shown in FIGS. 17-18, it is appreciated that corresponding order of filter coefficients can also be derived. It is evident from the examples shown in FIGS. 17-18 that any set of filter coefficients can be discarded after an output (i.e., output-1, output-2). As a results, the filter coefficient may be stored in first-in-first-out manner. However, each group of imagery data may be preserved as they may be reloaded for next set of filters. The imagery data may be stored in a memory (e.g., the first set of memory buffers) and reloaded.

The convolution operations between filter coefficients and imagery data are represented in the following formula:

Out(i)=F(i,j)⊗Im(j) (2)

where F(i,j) are filter coefficients of the i-th filter correlating to the j-th imagery data. Im(j) is the j-th imagery data. Out(i) is the i-th convolution operations result. In examples shown in FIGS. 17-18, i=1-8 while j=0.1-8, hence there are 8 Out(i), 8 Im(j) and 8×8=64 F(i,j) filter coefficients for each convolution layer. It is appreciated that other combinations of different numbers of imagery data, filters, CNN processing engines and I/O data bus can be similarly derived. If the number of imagery data is not a multiple of the number of CNN processing engines, any unfilled part is filled with zeros. Although two I/O data bus have been shown in the example connecting to CNN processing engines sequentially (i.e., the first half of the CNN processing engines to the first I/O data bus, the second half of the CNN processing engines to the second I/O data bus), I/O data bus may be connected to CNN processing engines differently. For example, in an alternating manner, CNN processing engines with odd number are coupled to the first I/O data bus, the others coupled to the second I/O data bus.

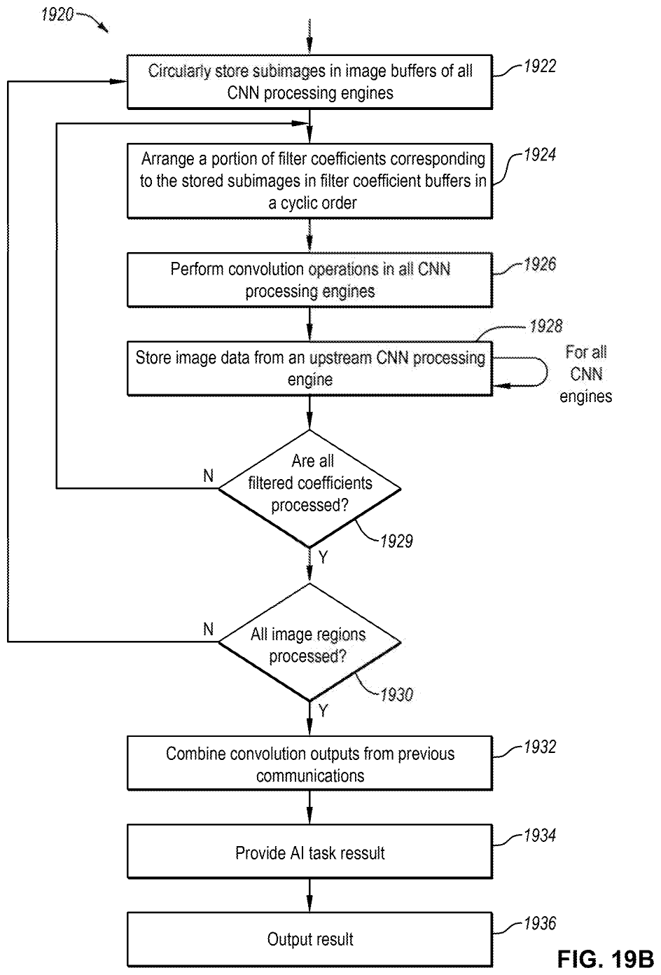

FIG. 19A is a flow diagram illustrating an example process 1900 of arranging imagery data and filter coefficients stored in a CNN based digital IC for performing AI tasks, e.g., extracting features out of an input image, in accordance with some embodiments of the invention. The CNN based digital IC is configured with NE number of CNN processing engines connected in a loop via a clock-skew circuit (e.g., a group of CNN processing engines shown in FIG. 16). NE is a positive integer. In one embodiment, NE is 16. Process 1900 may be implemented in software or hardware, e.g., an AI chip.

Process 1900 may include determining the number of imagery data groups required for storing all NIM sets of imagery data in the CNN processing engines at operation 1902. NIM is a positive integer. In one embodiment, NIM is 64. Each of the NIM sets of imagery data may contain one of the colors or distance or angle of the input image. One method to determine the number of imagery data groups is to divide NIM by NE and to make sure that one additional imagery data group to hold the remaining one if necessary. As a result, each imagery data group contains NE sets of imagery data.

At operation 1904, the NE sets of imagery data are circularly stored in respective CNN processing engines. In other words, one set of imagery data is stores in a corresponding CNN processing engine. The remaining imagery data groups are then stored in the same manner (i.e., circularly). The examples in FIGS. 17-18 show a first imagery data group contains sets 1-4 circularly stored in CNN processing engines 1-4. And a second imagery data group contains sets 5-8 also stored in CNN processing engines 1-4 circularly.

At operation 1906, the number of filter groups required for storing all NF number of filter coefficients is determined. NF is a positive integer. In one embodiment, NF is 256. Each of the NF number of filters contains NIM sets of filter coefficients. In other words, the total number sets of filter coefficients is NF multiplied by NIM. Each filter group contains NE sets of filter coefficients (i.e., a portion of the NIM sets). Each filter group is further divided into one or more subgroups with each subgroup containing a portion of the NE sets that correlates to a corresponding group of the imagery data groups.

At operation 1908, the portion of the NE sets of filter coefficients is stored in a corresponding one of the CNN processing engines. The portion of filter coefficients is arranged in a cyclic order for accommodating convolution operations with imagery data received from an upstream neighbor CNN processing engine. At operation 1908, the process is repeated for any remaining subgroups and any remaining filter groups. The cyclic order is demonstrated in the examples shown in FIGS. 17-18.

When there are more than one I/O data bus configured on the CNN based digital IC, the order of imagery data and filter coefficients transmitted on the I/O data bus is adjusted in accordance with the connectivity between each I/O data bus with CNN processing engines. For example, a CNN based digital IC contains 16 CNN processing engines with two I/O data bus. The first I/O data bus connects to CNN processing engines #1-#8 while the second I/O data bus connects to CNN processing engines #9-#16. There are 32 sets of imagery data and 64 filters. Imagery data transmitted on the first I/O data bus is in the order of sets #1-#8 and #17-#24. Sets #9-#16 and #25-#32 are transmitted on the second I/O data bus. Similarly, the filter coefficients for filters 1-8, 17-24, 33-40 and 49-54 are on the first I/O data bus. Others are on the second I/O data bus. Similar configurations of filter coefficients may be arranged for each of the convolution layers in the CNN processing engines.

The data arrangement in a CNN based digital IC is in a parallel manner. In other words, each of the CNN processing engines requires a specific cyclic order or sequence of the filter coefficients. However, imagery data and filter coefficients are transmitted through the at least one I/O data bus in a sequential order. To demonstrate how the order of filter coefficients is arranged in each of the 16 CNN processing engines of a CNN based digital IC, an example pseudo-code for verifying 128 filters with 64 imagery data is listed as follows:

#include <unistd.h>
#include <stdio.h>
#include <stdlib.h>
#include <string.h>
#include <errno.h>
int read_flt(const char* fname, int out, double *bias,
double *flt);
int write_flt (const char* fname, int in, double *gain,
double *bias);
int main(int argc, char** argv) {

double bias[128];
double flt [3*3*64*128];
char f_name [80];
int out;
int in;
int out_size = 129;
int in_size = 65;
for (out = 1; out <out_size; out++) {

sprintf (f name, “flt_cnn/v6_%d.flt”, out);
read_flt (f_name, out, bias, fit);

}
for (in = 1; in < 17; in++) {// 16 processing engines

sprintf(f_name, “../infile/flt_%d.in”, in);
write_flt(f_name, in, fit, bias);

}
return(0);

}
int read_flt(const char *fname, int out, double *bias,
double *flt) {

FILE *fp;
char *line = NULL;
size_t len = 0;
ssize_t read;
int i, j;
double data;
fp = fopen(fname, “r”);
read = getline (&line, &len, fp); //skip
read = getline (&line, &len, fp);
sscanf(line, “%if”, &data);
bias [out−1] = data;
int n;
int in_size = 65;
int im size = 64;
for (n = 1; n < in size; n++) {

for (i = 0; i < 3; i++) {

read = getline (&line, &len, fp); //skip
for (j = 0; j < 3; j++) {

read = getline (&line, &len, fp); //skip
read = getline (&line, &len, fp);
sscanf (line, “%if”, &data);
flt[(our−1)*9*im_size+(n−1)*9+i*3+j] = data;

}

}
read = getline (&line, &len, fp); //skip

}
fclose(fp);
return (0);

}
int write_flt(const char* fname, int in, double *gain,
double *bias) {

FILE *fp;
fp = fopen(fname, “w”);
int val;
double shift = 8192.0; //shift 13-bits (12-bit data)
int n, m, k;
int index, n1664, m16, in164;
printf(“\n in =%d:”, in);
in164 = (in−1)*64;
for (n = 1; n < 9; n++) { // 128/16 filter groups
n1664 = (n−1)*16*64;
for (m = 1; m < 5; m++) { // 64/16 imagery data groups
m16 = (m−1)*16;

printf(“\n n = %d m = %d :\t”, n, m);
if(in < 16) {

for (index = in; index > 0; index−−) { //1st set

printf(“%d, ”, n1664+in164+in164+m16+index);
for (k = 0; k < 9; k++) {

val = gain[(n1664+in164+m16+index−1)*9+k] * shift;
val = val & 4095;
fprintf(fp, “%.3x ”, val);

} //for k
val = 0;
fprintf(fp, “%.3x\n”, val);

} //for index
for (index = 16; index > in+1; index−−) { //2nd set

printf(“%d, ”, n1664+in164+m16+index);
for (k = 0; k < 9; k++) {

val = gain[(n1664+in164+m16+index−1)*9+k] * shift;
val = val & 4095;
fprintf(fp, “%.3x ”, val);

} //for k
val = 0;
fprintf(fp, “%.3x\n”, val);

} //for index
index = in+1;
printf(“%d, ”, n1664+in164+m16+index);
for (k = 0; k < 9; k++) { // last

val = gain[(n1664+in164+m16+index−1)*9)+k] * shift;
val = val & 4095;
fprintf(fp, “%.3x ”, val);

} //for k
if(m == 4) {

val = bias[(n−1)*16 + (in−1)+ * shift;
val = val & 4095;
fprintf(fp, “%.3x\n”, val);

} else {

val = 0;
fprintf(fp, “%.3x\n”, val);

}

} else { // for in == 16

for (index = in; index > 1; index−−) {

printf(“%d, ”, n1664+in164+m16+index);
for (k = 0; k < 9; k++) {

val = gain[(n1664+in164+m16+index−1)*9)+k] * shift;
val = val & 4095;
fprintf(fp, “%.3x ”, val);

} //for k
val = 0;
fprintf(fp, “%.3x\n”, val);

} //for index
index = 1;
printf(“%d, ”, n1664+in164+m16+index);
for (k = 0; k < 9; k++) { // last

val = gain+(n1664+in164+m16+index−1)*9+k] * shift;
val = val & 4095;
fprintf(fp, “%.3x ”, val);

} //for k
if (m == 4) {

val = bias[(n−1)*16 + (in−1)] * shift;
val = val & 4095;
fprintf(fp, “%.3x\n”, val);

} else {

val = 0;
fprintf(fp, “%.3x\n”, val);

}

} //in == 16

} //for m
} //for n
printf(“\n”);
fclose(fp);
return (0);

}

FIG. 19B is a flow diagram of an example process of performing an AI task using multiple CNN processing engines according to some examples described in the disclosure. In some examples, a process 1920 may include circularly storing sub-images in image buffers of all CNN processing engines at operation 1922. The process may circularly store the plurality of sub-images of an input image in a respective image buffer of the multiple CNN processing engines, wherein each sub-image represents an image region of a plurality of image regions of the input image. The process 1920 may further include arranging a portion of filter coefficients corresponding to the stored sub-image in a respective filter coefficient buffer of the multiple CNN processing engines in a cyclic order at operation 1924, the details of which are described with reference to FIGS. 17A-17C and 18A-18C.

In some examples, the operation 1924 may handle duplicate weights in a CNN processing engine, in which duplicate weights are not stored in duplicate memory space. For example, the filter coefficients of the first convolution layer and the second convolution layer of a CNN processing engine are duplicate. The operation 1924 may include storing a sub-portion of the portion of filter coefficients corresponding to the first convolution layer of the CNN processing engine at a first memory location, and storing the address of the first memory location at a second memory location corresponding to a second convolution layer of the CNN processing engine. As such, the memory space is saved because the duplicate weights of the second convolution layers are not physically stored in the memory. Instead, an address to a reference convolution layer (e.g., the first convolution layer) is stored. Various examples of arranging the filter coefficients with duplicate weights were described in the present disclosure, e.g., in FIGS. 4B, 4C and 5, are also applicable to the process 1920.

The process 1920 may further perform convolution operations in all of the CNN processing engines at operation 1926. In some examples, once the image buffers and filter coefficient buffers coupled to each CNN processing engines are loaded, the multiple CNN processing engines may be executed simultaneously. For each of the CNN processing engines, the process 1920 may store the image data from an upstream CNN processing engine at operation 1928 for all CNN processing engines. For example, the upstream CNN processing engine may be a neighbor CNN processing engine immediately preceding a current CNN processing engine in the loop circuit, where the loop circuit which may be controlled to feed output of the convolution operations performed in each of the CNN processing engines in a first clock cycle to a respective neighbor CNN processing engine in the loop circuit simultaneously in a next clock cycle after the first clock cycle. As such, the storing of the image data for all CNN processing engines may be completed in one clock cycle.

With further reference to FIG. 19B, the process 1920 may repeat operations 1924-1928 in one or more iterations until all filter coefficients are processed at 1929. In some examples, in each iteration, a portion of the filter coefficients are arranged for use by the multiple CNN processing engines. In a non-limiting example, there are a totally of 64 filters and 16 CNN processing engines. In the first iteration, 16 filters (e.g., filters 1-16) are loaded to the CNN processing engines; in the second iteration, filters 17-32 are loaded to the CNN processing engines; in the third and fourth iterations, filters 33-48 and 49-64 are respectively loaded to the CNN processing engines. Once the process 1920 determines that all filter coefficients are processed at 1929, the process may proceed to operation 1930.

In some examples, the process 1920 may repeat operations 1922-1929 in one or more iterations until all image regions of the input image are processed at 1930. For example, in each iteration, the process may store different sub-images in the image buffers of the CNN processing engines (e.g., in operation 1922), prepare the filter coefficient buffers of the CNN processing engines in operation 1924, and perform convolution operations at 1926 using the new sub-image and filter coefficient data corresponding to the sub-image. The process 1920 may further include combining the convolution outputs from previous convolutions at operation 1932. In some examples, process 1920 may accumulatively combine the previous convolution outputs. For example, in each convolution operation, the output may be saved in a memory and combined with the output of the next convolution operation (e.g., via adder 921 and multiplexer 922 in FIG. 9). At this point, the previous convolution output may be discarded and the current convolution operation output is stored. In other words, only the output of the most recent convolution operation is stored.

The process 1920 may further provide an AI task output based on the combined convolution outputs at operation 1934 and output the result at 1936. Examples of performing AI tasks using the AI chip are described in the present disclosure.

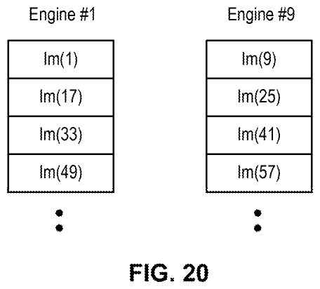

One example scheme to transmit imagery data and filter coefficients through the at least one I/O data bus is to arrange imagery data and filter coefficients for each of the CNN processing engines. Example imagery data arrangement of a CNN based digital IC with 16 CNN processing engines is shown in FIG. 20. The imagery data order for the first CNN processing engine is arranged in the following order: (imagery data 1-17-33-49- . . . ). The order for the ninth CNN processing engine is as follows: (imagery data 9-25-41-57- . . . ). When a first I/O data bus connects CNN processing engines 1-8 and a second I/O data bus connects CNN processing engines 9-16, the example imagery data orders shown in FIG. 20 are the beginning of respective I/O data bus.

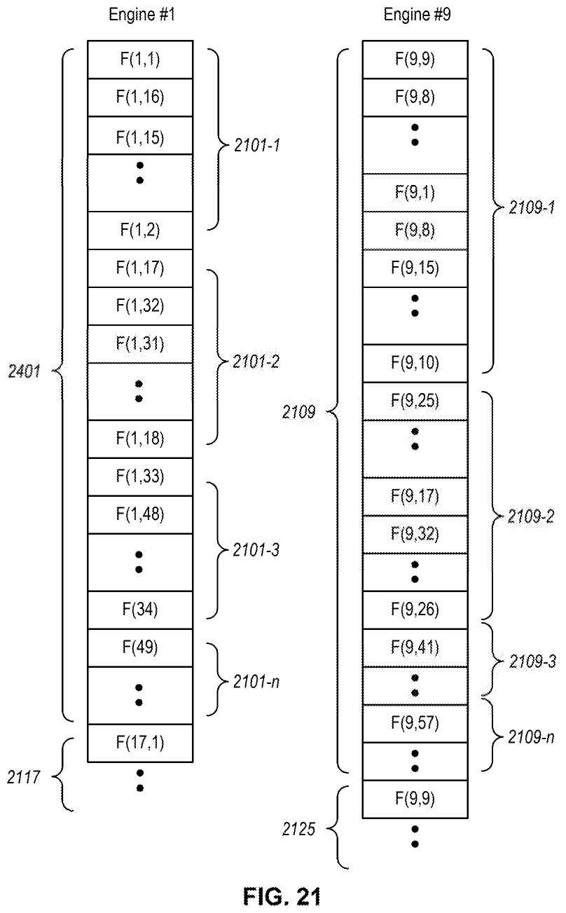

FIG. 21 is a diagram showing example data arrangement of filter coefficients a CNN based digital IC having 16 CNN processing engines. In some examples, filter coefficients for the first filter 2101 are stored in CNN processing engine #1. Filter coefficients for the second filter are stored in CNN processing engine #2 (not shown). Coefficients for the ninth filter 2109 are stored in CNN processing engine #9. Since there are 16 CNN processing engines, filter coefficients for filters 1-16 are stored in respective CNN processing engines as a first filter group. In the second filter group, filter coefficients for the 17th filter 2117 are stored in CNN processing engine #1. And filter coefficients for the 25th filter 2125 are stored in CNN processing engine #9, etc.

In some examples, filter coefficients of the first filter are further divided into one or more subgroups containing a portion correlated to a corresponding imagery data group. Filter coefficient of the first subgroup within the first filter 2101 is a portion that correlates to the first imagery data group (i.e., imagery data 1-16). The second subgroup 2101-2 containing another portion that correlates to the second imagery data group (i.e., imagery data 17-32). The third subgroup 2101-3 correlates to the third imagery data group (i.e., imagery data 3348). The remaining subgroups 2101-n correlate to remaining corresponding imagery data. Subgroups for the 17th filter are similarly created (not shown).

Similarly, for the ninth filter, the first subgroup 2109-1, the second subgroup 2109-2, the third subgroup 2109-3 and the remaining subgroup 2109-n correlate to respective imagery data groups. Filter coefficients order of each filter are different depend upon not only the number of CNN processing engines and how the CNN processing engines are connected via clock-skew circuit, but also the number of filters and the number of imagery data.

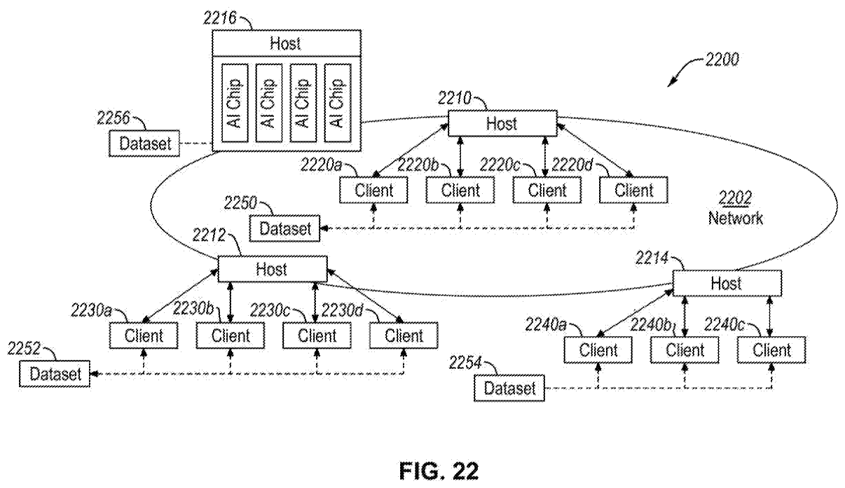

FIG. 22 illustrates an example training system in accordance with various examples described herein. In some examples, a training system 2200 may be implemented to train an AI model (e.g., a CNN model) for loading into an AI chip. In some examples, the AI chip may include one or more CNN processing engines (e.g., 222 in FIG. 2A, 252, 262 in FIG. 2B, 402 in FIG. 4A). The training system 2200 may include a communication network 2202. Communication network 2202 may include any suitable communication links, such as wired (e.g., serial, parallel, optical, or Ethernet connections) or wireless (e.g., Wi-Fi, Bluetooth, or mesh network connections), or any suitable communication protocols now or later developed. In some scenarios, system 2200 may include one or more host devices, e.g., 2210, 2212, 2214, 2216. A host device may communicate with another host device or other devices on the network 2202. A host device may also communicate with one or more client devices via the communication network 2202. For example, host device 2210 may communicate with client devices 2220a, 2220b, 2220c, 2220d, etc. Host device 2212 may communicate with client devices 2230a, 2230b, 2230c, 2230d, etc. Host device 2214 may communicate with client devices 2240a, 2240b, 2240c, etc. A host device, or any client device that communicates with the host device, may have access to one or more training datasets for training an AI model. For example, host device 2210 or a client device such as 2220a, 2220b, 2220c, or 2220d may have access to the dataset 2250.

In FIG. 22, a client device may include a processing device. A client device may also include one or more AI chips. In some examples, a client device may be an AI chip. The AI chip may be a physical AI IC. The AI chip may also be software-based, such as a virtual AI chip that includes one or more process simulators to simulate the operations of a physical AI IC. A processing device may include an AI chip and contain programming instructions that will cause the AI chip to be executed in the processing device. Alternatively, and/or additionally, a processing device may also include a virtual AI chip, and the processing device may contain programming instructions configured to control the virtual AI chip so that the virtual AI chip may perform certain AI functions. In FIG. 22, each client device (e.g., 2220a, 2220b, 2220c, 2220d) may be in electrical communication with other client devices on the same host device, e.g., 2210, or client devices on other host devices.

In some examples, the training system 2200 may be a centralized system. System 2200 may also be a distributed or decentralized system, such as a peer-to-peer (P2P) system. For example, a host device, e.g., 2210, 2212, 2214, and 2216, may be a node in a P2P system. In a non-limiting example, a client devices, e.g., 120a, 120b, 120c, and 120d may include a processor and an AI physical chip. In another non-limiting example, multiple AI chips may be installed in a host device. For example, host device 2216 may have multiple AI chips installed on one or more PCI boards in the host device or in a USB cradle that may communicate with the host device. Host device 2216 may have access to dataset 156 and may communicate with one or more AI chips via PC board(s), internal data buses, or other communication protocols such as universal serial bus (USB).

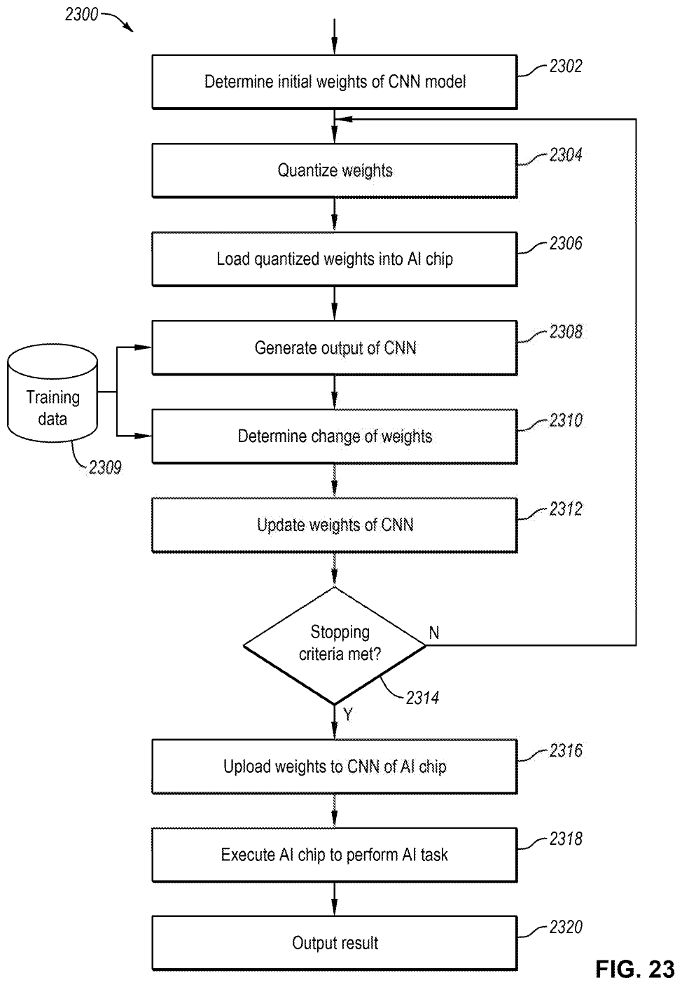

With further reference to FIG. 22, a host device on a communication network as shown in FIG. 22 (e.g., 2210) may include a processing device and contain programming instructions that, when executed, will cause the processing device to access a dataset, e.g., 2250, for example, test data. The training data may be provided for use in training the AI model. For example, training data may be used for training an AI model that is suitable for an AI task, such as a face recognition tasks, and the training data may contain any suitable dataset collected for performing face recognition tasks. In another example, the training data may be used for training an AI model suitable for scene recognition in video and images, and may contain any suitable scene dataset collected for performing scene recognition tasks. In some scenarios, training data may reside in a memory in a host device. In one or more other scenarios, training data may reside in a central data repository and is available for access by a host device (e.g., 2210, 2212, 2214 in FIG. 22) or a client device (e.g., 2220a-d, 2230a-d, 2240a-d in FIG. 22) via the communication network 2202. In some examples, system 2200 may include multiple training data sets, such as datasets 2250, 2252, 2254. A CNN model may be trained by using one or more devices and/or one or more AI chips in a communication system such as shown in FIG. 22. Details are further described with reference to FIGS. 23-26.

FIG. 23 illustrates a flow diagram of an example process of training and executing an AI model in accordance with various examples described herein. A training process 2300 may perform operations in one or more iterations to train and update the weights of a CNN model, where the trained weights may be output in fixed point, which are suitable for a hardware to execute, such as an AI chip. In some examples, the training process 2300 may include determining initial weights of a CNN model at 2302, and quantizing the weights of the CNN at 2304. In some examples, the process may determine the initial weights in various ways. For example, the process may determine the initial weights randomly. The process may also determine the initial weights according to a pre-trained AI model. In some examples, the initial weights or later updated weights (unquantized weights) may be stored in floating point suitable for training in a desktop environment (e.g., a host device in the system 2200 in FIG. 22). For example, the unquantized weights may be stored in 32-bit or 64-bit.

In some examples, quantizing the weights at 2304 may include converting the weights from floating points to fixed points for uploading to an AI chip. Quantizing the weights at 2304 may include quantizing the weights according to the one or more quantization levels. In some examples, the number of quantization levels may correspond to the hardware constraint of the AI chip so that the quantized weights can be uploaded to the AI chip for execution. For example, the AI chip may include an embedded CNN processing block (e.g., 224 in FIG. 2A, 254 in FIG. 2B, 404 in FIG. 4A) or multiple CNN processing blocks. In the embedded CNN processing block, the weights may include 1-bit (binary value), 2-bit, or other suitable bits, such as 5-bit. In case of 1-bit, the number of quantization levels will be two.

In some scenarios, quantizing the weights to 1-bit may include determining a threshold to properly separate the weights into two groups: one below the threshold and one above the threshold, where each group takes one value, such as {1, −1}. In some examples, quantizing the weights into two quantization levels may include a uniform quantization in which a threshold may be determined at the middle of the range of the weight values, such as zero. In such case, the weights having positive values may be quantized to a value of 1 and weights having a negative or zero value may be quantized to a value of −1. In some examples, determining the threshold for quantization may be based on the values of the weights to be quantized or the distribution of the weights.

With further reference to FIG. 23, the process 2300 may further determine the output of the CNN model at 2308 based at least on a training data set and the quantized weights of the CNN model. In some examples, determining the output of the CNN model at 2308 may be performed on a CPU or GPU processor outside the AI chip. In some or other scenarios, determining the output of the CNN model may also be performed directly in an AI chip, where the AI chip may include one or more CNN processing engines, e.g., 222 in FIG. 2A, 252, 262 in FIG. 2B, 400 in FIG. 4A. In that case, the process 2300 may include loading quantized weights into one or more CNN processing engines of the AI chip at 2306 for execution of the AI model. In some examples, loading the weights to an AI chip may include storing the quantized weights into respective filter coefficient buffers of one or more CNN processing engines in the AI chip.

The process 2300 may further include determining a change of weights at 2310 based on the output of the CNN model. In some examples, the output of the CNN model may be the output of the activation layer of the CNN. The process 2300 may further update the weights of the CNN model at 2312 based on the change of weights. The process may repeat updating the weights of the CNN model in one or more iterations. In some examples, blocks 2308-2312 may be implemented using a gradient descent method. For example, a loss function may be defined as:

$${H}_{{Y}_{i}} ( Y ) \text{:=} - {\sum }_{i} {Y}_{i}^{′} log ( {Y}_{i} )$$

where Y′ᵢ is the ground truth of ith training instance, and Yᵢ is the prediction of the network, e.g., the output of the CNN based on the ith training instance. In other words, the loss function H( ) may be defined based on a sum of loss values over a plurality of training instances in the training data set, wherein the loss value of each of the plurality of training instances is a difference between an output of the CNN model for the training instance and a ground truth of the training instance. In some examples, the prediction Yᵢ in the cost function may be calculated by a softmax classifier in the CNN model.

In some examples, the gradient descent may be used to determine a change of weight

ΔW=f(W_{Q}^{t})

by minimizing the loss function H( ), where W_{Q}^{t} stands for the quantized weights at time t. The process may update the weights from a previous iteration based on the change of weight, e.g., W^{t+1}=W^{t}+ΔW, where W^{t} and W^{t+1} stand for the weights in a preceding iteration and the weights in the current iteration, respectively. In some examples, the weights (or updated weights) in each iteration, such as W^{t} and W^{t+1}, may be stored in floating point. The quantized weights W_{Q}^{t} at each iteration t may be stored in fixed point. In some examples, the gradient descent may include known methods, such as a stochastic gradient descent method.

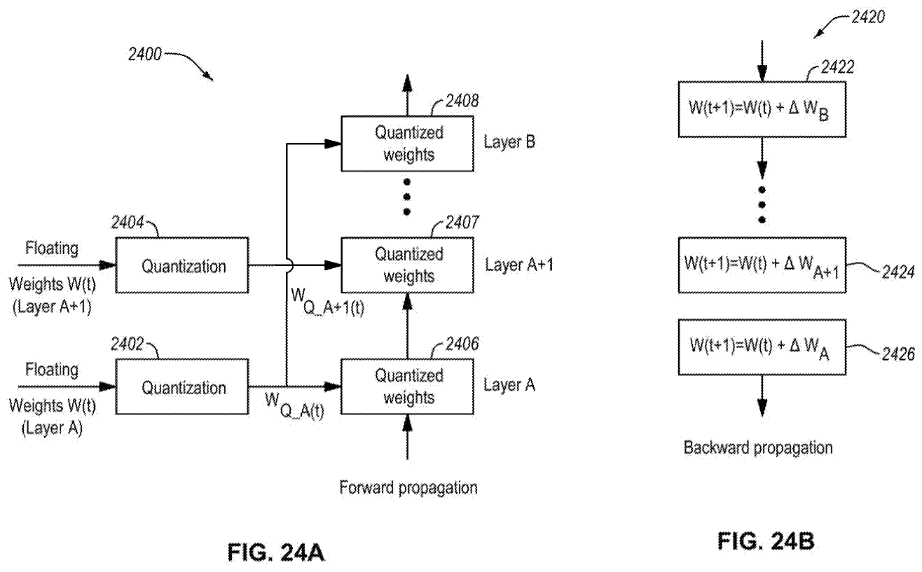

FIGS. 24A and 24B are flow diagrams of example forward and backward propagations in a training process, which may be implemented in the process 2300 (in FIG. 23). In the example in FIGS. 24A and 24B, the weights in convolution layer B duplicates the weights in the convolution layer A. In some examples, layers A and B may respectively correspond to a first convolution layer and a second convolution layer in a CNN processing block (e.g., 224 in FIG. 2A, 254 in FIG. 2B, 404 in FIG. 4A). In some examples, the forward propagation process includes feeding an output of one convolution layer to the input of a succeeding convolution layer. As shown in FIG. 24A, in a forward propagation network 2400, the floating-point weights W_{A}(t) at time t of convolution layer A of a CNN model may be quantized at 2402. The floating-point weights W_{A+1}(t) at time t of convolution layer A+1 of the CNN model may be quantized at 2404. For example, the quantization at 2402, 2404 may be implemented in operation 2304 (in FIG. 23). The quantized weights W_{Q-A}(t) and W_{Q-A+1}(t) may be respectively loaded to the convolution layers A and A+1 (2406, 2407) of the CNN processing block, which operations may, for example, be implemented in operation 2306 (in FIG. 23). Layer B duplicates the weights from layer A, accordingly, the quantized weights from layer A, W_{Q-A}(t) are loaded to the layer B of the CNN processing block 2408.

In the forward-propagation operation, the output at each convolution layer may be generated based on the loaded quantized weights and then fed to the input of the succeeding layer. For example, the output of layer A may be fed to the input of layer A+1, so on and so forth, and the output of the preceding layer of layer B is fed to the input of layer B.

In FIG. 24B, in a backward propagation network 2420, each of the convolution layers of the CNN model may be updated based on a change of weights. For example, the change of weights may be determined as described with respect to 2310 in FIG. 23. In the example in FIG. 24B, the updated weights at time t+1 for convolution layer B is determined as W_{B}(t+1)=W_{B}(t)+ΔW_{B}; the updated weights for convolution layer A+1 may be determined as W_{A}+(t+1)=W_{A+1}(t)+ΔW_{A+1}; and the updated weights for convolution layer A may be determined as W_{A}(t+1)=W_{A}(t)+ΔW_{A}, where ΔW_{B}, ΔW_{A+1} and AWA represent the change of weights for convolution layers B, A+1, and A, respectively. Updating the weights may be implemented in operation 2312 in FIG. 23. In a back-propagation network, the change of weights for a layer may be determined based on the error of the previous layer, which translates to the succeeding layer in the forward propagation. For example, in FIG. 24B, ΔW_{A} may be determined based on the error of the convolution layer A+1, where the error may be based on the inference (output) of layer A+1. As described in the present disclosure, a gradient descent, such as a stochastic gradient descent method may be used to determine the change of weights. This operation can be performed on a layer by layer basis.

In the above example, because the weights of layer B duplicates those of layer A, the weights of layer A may be updated based on the change of weights ΔW of layer A, layer B, and/or a combination of ΔW_{B} and ΔW_{A}. For example, the weights of layer A may be updated as W_{A}(t+)=W_{A}(t)+ΔW_{A}, or W_{A}(t+1)=W_{A}(t)+ΔW_{H}. Alternatively, the weights of layer A may be updated based on the combination of ΔW_{B} and ΔW_{A}, for example, the average of ΔW_{B} and ΔW_{A}, e.g., (ΔW_{A}+ΔW_{H})/2. The remaining layers in the CNN processing block may be updated in the similar manner.

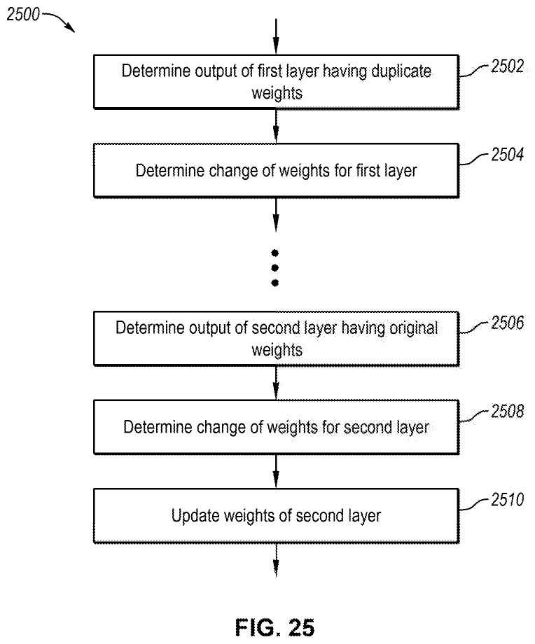

FIG. 25 is a flow diagram of an example process of updating the weights of a CNN model. In the example in FIG. 25, a first layer of a CNN engine may duplicate the weights of a second layer having original weights. A process 2500 may be implemented in one or more operations of 2308, 2310 and/or 2312 (in FIG. 23). For example, the process 2500 may include determining the output of the first layer having the duplicate weights at 2502 and determining an error of the first layer at 2504 based on the output of the first layer. The process 2500 may process the other layers in a similar manner. In processing the layers having duplicate weights, for example, the process 2500 may also include determining the output of the second layer having the original weights at 2506 and determining the error of the second layer at 2508 based on the output of the second layer. The process 2500 may further include updating the weights of the second layer at 2510. The process may update the weights of the second layer based on the change of weights for the second layer, the change of weights for the layer having the duplicate weights (e.g., the first layer), and/or a combination thereof. In combining the change weights of the first and second layer, in a non-limiting example, the combined change of weights may be the average of the changes of weights for the two layers. Other methods of combining the change of weights for the first and second layers may also be possible.

Returning to FIG. 23, the process 2300 may repeat blocks 2304 to 2312 iteratively, in one or more iterations until a stopping criteria is being met. For example, at each iteration, the process 2300 may determine whether a stopping criteria has been met at 2314. If the stopping criteria has been met, the process may upload the quantized weights of the CNN model at the current iteration to an AI chip at 2316. In some examples, uploading the quantized weights of the CNN model to the AI chip may include circularly storing the trained weights to respective filter coefficient buffers of one or more CNN processing engines in the AI chip. Examples are provided with reference to FIGS. 4A, 4B, 17A-17C and 18A-18C.

In some examples, if the stopping criteria has not been met, the process 2300 may repeat blocks 2304 to 2312 in a new iteration. In determining whether a stopping criteria has been met, the process 2300 may count the number of iterations and determine whether the number of iterations has exceeded a maximum iteration number. For example, the maximum iteration may be set to a suitable number, such as 100, 200, or 1000, or 10,000, or an empirical number. In some examples, determining whether a stopping criteria has been met may also determine whether a value of the loss function at the current iteration is greater than a value of the loss function at a preceding iteration. If the value of the loss function increases, the process 2300 may determine that the iterations are diverting and determine to stop the iterations.

In some examples, blocks 2304-2314 may be repeated iteratively in a layer-by-layer fashion for multiple convolution layers in a CNN model. In such case, the weights are updated in each of the multiple convolution layers of the CNN model. Upon the completion of iterations for all of the multiple convolution layers, the process 2300 may proceed with uploading the quantized weights of the multiple convolution layers of the CNN model at 2316.

Once the trained quantized weights are uploaded to the AI chip, the process 2300 may further include executing the AI chip to perform an AI task at 2318 in a real-time application, and outputting the result of the AI task at 2320. In training the weights of the CNN model, the AI chip may be a physical AI chip, a virtual AI chip or a hybrid AI chip, and the AI chip may be configured to execute the CNN model based on the trained weights. The AI chip may be residing in any suitable computing device, such as a host or a client shown in FIG. 22. In a non-limiting example, the training data 2309 may include a plurality of training input images. The ground truth data may include information about one or more objects in the image, or about whether the image contains a class of objects, such as cats, dogs, human faces, or a given person's face. The output of the CNN model may include recognition result indicating a class to which the input image belongs. In the training process, such as 2300, the loss function may be determined based on the labels of classes of images in the ground truth and the prediction (e.g., the recognition result) generated from the AI chip based on the training input image. For example, the prediction Yᵢ may be the probability of the image belonging to a class, e.g., a cat, a dog, a human face etc., where the probability may be calculated by a softmax classifier in the CNN.

In a non-limiting example, the trained weights of a CNN model may be uploaded to the AI chip. For example, the quantized weights may be uploaded to an embedded CNN processing engine (e.g., 222 in FIG. 2A, 252, 262 in FIG. 2B, 400 in FIG. 4A) of the AI chip so that the AI chip may be capable of performing an AI task, such as recognizing one or more classes of object from an input image, e.g., a cry and a smiley face. In an example application, an AI chip may be installed in a camera and store the trained weights and/or other parameters of the CNN model, such as those quantized weights generated in the process 2300. The AI chip may be configured to receive a captured image from the camera, perform an image recognition task based on the captured image and the stored CNN model, and transmit the recognition result to an output display. For example, the camera may display, via a user interface, the recognition result. In a face recognition application, the CNN model may be trained for face recognition. A captured image may include one or more facial images associated with one or more persons. The recognition result may include the names associated with each input facial image. The AI chip may transmit the recognition result to the camera, which may present the output of the recognition result on a display. For example, the user interface may display a person's name next to or overlaid on each of the input facial image associated with the person.

It is appreciated that the disclosures of various embodiments in FIGS. 1-25 may vary. For example, whereas the input image has been shown and described as partitioning into M-pixel by M-pixel blocks in certain order, other orders may be used in the invention to achieve the same, for example, the ordering of the M-pixel by M-pixel blocks may be column-wise instead of row-wise. Furthermore, whereas M-pixel by M-pixel blocks have been shown and described using M equals to 14 as an example. M can be chosen as other positive integers to accomplish the same, for example, 16, 20, 30, etc. Additionally, whereas the convolution mask of 3×3 and a 2×2 pooling have been shown and described, other types of convolution and pooling operations, e.g., 5×5 convolution and 3×3 pooling, may be used. Other suitable types may also be possible.

Although examples of performing convolutions over input images are provided, the systems and methods described in the present disclosure are not limited to processing images captured from an image capturing sensor. For example, the systems and methods described herein may be applied to a voice recognition application, in which audio signals captured by an audio sensor may be converted to a two-dimensional (2D) spectrogram. In addition, variations of the processes in FIG. 23 may be possible. In a non-limiting example, another training process may provide initial weights of the process 2300. Alternatively, and/or additionally, the trained weights from the process 2300 may serve as the initial weights of a third process. Similarly, the training process 2300 may be performed multiple times, each using a separate training set. Further, the operations in processes 2300 (FIG. 23) may be performed entirely in a CPU/GPU processor. Alternatively, certain operations in these processes may be performed in an AI chip while other operations are performed in a CPU/GPU processor. It is appreciated that other variations may be possible.

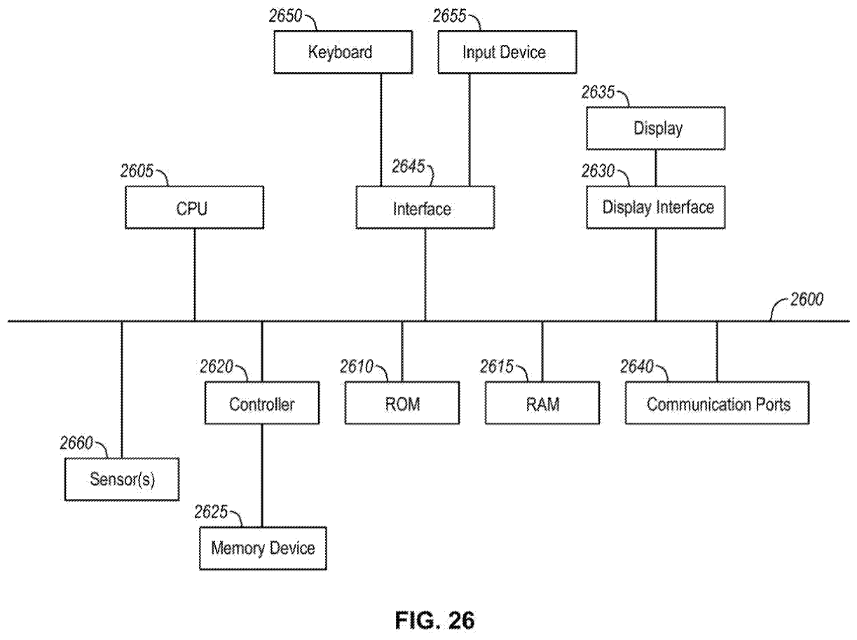

FIG. 26 depicts an example of internal hardware that may be included in any electronic device or computing system for implementing various methods in the embodiments described in FIGS. 1-25. For example, the hardware depicted in FIG. 26 may be implemented in the controller of a CNN processing engine (e.g., 210 in FIG. 2), various control circuits in FIGS. 3, 4, 16, and any of the host or client devices in FIG. 22. An electrical bus 2600 serves as an information highway interconnecting the other illustrated components of the hardware. Processor 2605 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU) or a combination of the two. Read only memory (ROM), RAM, flash memory, hard drives, and other devices capable of storing electronic data constitute examples of memory devices 2625. A memory device, also referred to as a computer-readable medium, may include a single device or a collection of devices across which data and/or instructions are stored.

An optional display interface 2630 may permit information from the bus 2600 to be displayed on a display device 2635 in visual, graphic, or alphanumeric format. An audio interface and audio output (such as a speaker) also may be provided. Communication with external devices may occur using various communication ports 2640 such as a transmitter and/or receiver, antenna, an RFID tag and/or short-range, or near-field communication circuitry. A communication port 2640 may be attached to a communications network, such as the Internet, a local area network, or a cellular telephone data network.

The hardware may also include a user interface sensor 2645 that allows for receipt of data from input devices 2650 such as a keyboard, a mouse, a joystick, a touchscreen, a remote control, a pointing device, a video input device, and/or an audio input device, such as a microphone. Digital image frames may also be received from an imaging capturing device 2655 such as a video or camera that can either be built-in or external to the system. Other environmental sensors 2660, such as a GPS system and/or a temperature sensor, may be installed on system and communicatively accessible by the processor 2605, either directly or via the communication ports 2640. The communication ports 2640 may also communicate with the AI chip to upload or retrieve data to/from the chip. For example, a trained AI model with updated quantized weights obtained from process 2300 may be shared by one or more processing devices on the network running other training processes or AI applications. A device on the network may receive the trained AI model from the network and upload the trained weights, to an AI chip for performing an AI task via the communication port 2640 and an SDK (software development kit). The communication port 2640 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on one or more of those virtual machines on the cloud.

Various embodiments described above may be implemented and adapted to various applications. For example, the AI chip having a CNN architecture may be residing in an electronic mobile device. The electronic mobile device may use the built-in AI chip to produce recognition results and generate performance values. In some scenarios, training the CNN model can be performed in the mobile device itself, where the mobile device retrieves training data from a dataset and uses the built-in AI chip to perform the training. In other scenarios, the processing device may be a server device in the communication network (e.g., 2202 in FIG. 22) or may be on the cloud. These are only examples of applications in which an AI task can be performed in the AI chip.

The various systems and methods disclosed in this patent document provide advantages over the prior art, whether implemented standalone or combined. For example, using the systems and methods described in FIGS. 1-26 may reduce the required memory space for storing the weights of an AI chip by allowing storing and accessing duplicates weights amongst various convolution layers. This facilitates configuration of deeper neural network or higher bits of filter coefficients for convolution operations, which will result in higher performance CNN chip without increasing the hardware requirement. Further, the various methods and systems for training an CNN chip that allow duplicate weights and quantization of weights help obtain an optimal AI model that may be executed in a physical AI chip with a performance close to an expected performance in the training process by mimicking the hardware configuration in the training process. Further, the quantization of weights and output values of one or more convolution layers may use various methods. The configuration of the training process described herein may facilitate both forward and backward propagations that would take advantage of classical training algorithms, such as gradient decent, in training weights of an AI model. Above illustrated embodiments are described in the context of training a CNN model for an AI chip, but can also be applied to various other applications. For example, the current solution is not limited to implementing the CNN but can also be applied to other algorithms or architectures inside an AI chip.

It will be readily understood that the components of the present solution as generally described herein and illustrated in the appended figures could be arranged and designed in a wide variety of different configurations. Thus, the detailed description of various implementations, as represented herein and in the figures, is not intended to limit the scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

We claim:

1. An integrated circuit comprising:
at least one input/output data bus;
a plurality of cellular neural networks (CNN) processing engines operatively coupled to the at least one input/output data bus, the plurality of CNN processing engines being coupled to form a loop circuit, each CNN processing engine comprising:
a CNN processing block comprising multiple convolution layers and configured to perform multiple convolution operations over an image at respective pixel locations of the image by using filter coefficients for each of the multiple convolution operations, wherein the filter coefficients comprise multiple subsets of filter coefficients each subset for a respective convolution layer of the CNN processing block;
a first set of memory buffers operatively coupled to the CNN processing block and configured to store imagery data representing the image; and
a second set of memory buffers operatively coupled to the CNN processing block and configured to store one or more subsets of the multiple subsets of filter coefficients to be fed into the CNN processing block, wherein at least one of the second set of memory buffers corresponds to a subset of filter coefficients for a first convolution layer of the CNN processing block and stores a reference location to a subset of filter coefficients for a second convolution layer of the CNN processing block, wherein the subsets of filter coefficients for the first and second convolution layers of the CNN processing block are duplicate.

2. The integrated circuit of claim 1 further comprises a controller configured to cause the CNN processing blocks of the plurality of CNN processing engines to simultaneously perform the multiple convolution operations.

3. The integrated circuit of claim 2, wherein the second set of memory buffers includes a plurality of duplicate indicators each associating with a respective convolution layer of the CNN processing block, and wherein the controller is configured to, for each of the multiple convolution operations:
(i) determine a current convolution layer;
(ii) access a duplicate indicator associated with the current convolution layer,
(iii) if a value in the duplicate indicator indicates a duplicate, access a corresponding subset of filter coefficients for a reference convolution layer of the CNN processing block; otherwise, access a subset of filter coefficients for the current convolution layer in a next memory block; and
(iv) perform a convolution operation for the current convolution layer based on the accessed subset of filter coefficients.

4. The integrated circuit of claim 3, wherein the controller is further configured to repeat operations (i)-(iv) in one or more iterations until all of the convolution layers in the CNN processing block are processed.

5. The integrated circuit of claim 2, wherein the input/output data bus is configured to, for a convolution operation of the multiple convolution operations, provide a corresponding portion of the imagery data to the first set of memory buffers and to provide a corresponding portion of the filter coefficients to the second set of memory buffers.

6. The integrated circuit of claim 5 further comprising a clock-skew circuit in the loop circuit, wherein the clock-skew circuit further comprises a plurality of D flip-flops.

7. The integrated circuit of claim 6 further comprising a plurality of multiplexers each coupled to a CNN processing block of a respective CNN processing engine of the plurality of CNN processing engines.

8. The integrated circuit of claim 7, wherein the clock-skew circuit and the multiplexer coupled to the CNN processing block are configured to feed the corresponding portion of the imagery data into the CNN processing block of said each of the plurality of CNN processing engines in a first clock cycle to be processed in a first neighbor CNN processing engine in a next clock cycle.

9. The integrated circuit of claim 8, wherein the clock-skew circuit and the multiplexer are configured to feed imagery data processed by a respective second neighbor CNN processing engine in a previous clock cycle to the CNN processing block of each of the multiple CNN processing engines.

10. The integrated circuit of claim 2, wherein the controller is configured to:
cause the integrated circuit to perform at least a portion of an artificial intelligence (AI) task to generate an AI task result based on outputs from the multiple convolution operations of the CNN processing blocks of one or more of the CNN processing engines; and
output the AI task result.

11. The integrated circuit of claim 1, wherein the first set of memory buffers includes nine buffers respectively configured to contain central portion of the image, four edge portions respectively containing an edge region of the image, and four corner portions respectively containing a corner of the image.

12. An integrated circuit comprising:
a first controller and a second controller;
a first set of at least one input/output data bus;
a second set of at least one input/output data bus;
a first plurality of cellular neural networks (CNN) processing engines operatively coupled to the first set of at least one input/output data bus, the first plurality of CNN processing engines being coupled to form a first loop circuit, each of the first plurality of CNN processing engines comprising:
a CNN processing block comprising multiple convolution layers and configured to perform multiple convolution operations over an image at respective pixel locations of the image by using filter coefficients for each of the multiple convolution operations, wherein the filter coefficients comprise multiple subsets of filter coefficients each for a respective convolution layer of the CNN processing block;
a first set of memory buffers operatively coupled to the CNN processing block and configured to store imagery data representing the image; and
a second set of memory buffers operatively coupled to the CNN processing block and configured to store one or more subsets of the multiple subsets of filter coefficients to be fed into the CNN processing block, wherein at least one of the second set of memory buffers corresponds to a subset of filter coefficients for a first convolution layer of the CNN processing block and stores a reference location to a corresponding subset of filter coefficients for a second convolution layer of the CNN processing block, wherein the subsets of filter coefficients for the first and second convolution layers of the CNN processing block are duplicate; and
a second plurality of CNN processing engines operatively coupled to the second set of at least one input/output data bus, the second plurality of CNN processing engines being coupled to form a second loop circuit, each of the second plurality of CNN processing engines comprising:
a CNN processing block comprising multiple convolution layers and configured to perform multiple convolution operations over an image at respective pixel locations of the image by using filter coefficients for each of the multiple convolution operations, wherein the filter coefficients comprise multiple subsets of filter coefficients each for a respective convolution layer of the CNN processing block;
a first set of memory buffers operatively coupled to the CNN processing block and configured to store imagery data representing the image; and
a second set of memory buffers operatively coupled to the CNN processing block and configured to store one or more subsets of the multiple subsets of filter coefficients to be fed into the CNN processing block, wherein at least one of the second set of memory buffers corresponds to a subset of filter coefficients for a first convolution layer of the CNN processing block and stores a reference location to a subset of filter coefficients for a second convolution layer of the CNN processing block, wherein the subset of filter coefficients for the first and second convolution layers of the CNN processing block are duplicate.

13. The integrated circuit of claim 12 further comprises a controller configured to cause the CNN processing blocks of the first and second plurality of CNN processing engines to simultaneously perform the multiple convolution operations.

14. The integrated circuit of claim 13, wherein, in each CNN processing engine of the first plurality of CNN processing engines and the second plurality of CNN processing engines, the second set of memory buffers of the CNN processing engine includes a plurality of duplicate indicators each associating with a respective convolution layer of the CNN processing block, and wherein the controller is configured to, for each of the multiple convolution operations:
(i) determine a current convolution layer;
(ii) access a duplicate indicator associated with the current convolution layer;
(iii) if a value in the duplicate indicator indicates a duplicate, access a respective subset of filter coefficients for a reference convolution layer of the CNN processing block; otherwise, access a subset of filter coefficients for the current convolution layer in a next memory block;
(iv) perform a convolution operation for the current convolution layer based on the accessed subset of filter coefficients; and
(v) repeat operations (i)-(iv) in one or more iterations until all of the convolution layers in the CNN processing block are processed.

15. The integrated circuit of claim 13, wherein the controller is configured to:
cause the integrated circuit to perform at least a portion of an artificial intelligence (AI) task to generate an AI task result based on outputs from the multiple convolution operations of the CNN processing blocks of one or more CNN processing engines of the first and second plurality of CNN processing engines; and
output the AI task result.

16. An integrated circuit comprising:
a first cellular neural networks (CNN) processing engine comprising:
a CNN processing block comprising multiple convolution layers and configured to perform multiple convolution operations over an image by using filter coefficients for each of the multiple convolution operations, wherein the filter coefficients comprise multiple subsets of filter coefficients each for a respective convolution layer of the CNN processing block;
a first set of memory buffers operatively coupled to the CNN processing block and configured to store imagery data representing the image; and
a second set of memory buffers operatively coupled to the CNN processing block and configured to store one or more subsets of the multiple subsets of filter coefficients to be fed into the CNN processing block, wherein at least one of the second set of memory buffers corresponds to a subset of filter coefficients for a first convolution layer of the CNN processing block and stores a reference location to a corresponding subset of filter coefficients for a second convolution layer of the CNN processing block, wherein the subsets of filter coefficients for the first and second convolution layers of the CNN processing block are duplicate.

17. The integrated circuit of claim 16 further comprising a controller, wherein the second set of memory buffers include a plurality of duplicate indicators each associating with a respective convolution layer of the CNN processing block, and wherein the controller is configured to, for each of the multiple convolution operations:
(i) determine a current convolution layer;
(ii) access a duplicate indicator associated with the current convolution layer;
(iii) if a value in the duplicate indicator indicates a duplicate, access a respective subset of filter coefficients for a reference convolution layer of the CNN processing block; otherwise, access a subset of filter coefficients for the current convolution layer in a next memory block; and
(iv) perform a convolution operation for the current convolution layer based on the accessed subset of filter coefficients.

18. The integrated circuit of claim 17, wherein the controller is configured to repeat operations (i)-(iv) in one or more iterations until all of the convolution layers in the CNN processing block are processed.

19. The integrated circuit of claim 16, wherein the first CNN processing engine further comprises a clock-skew circuit and a multiplexer coupled to the CNN processing block of the first CNN processing engine, wherein the clock-skew circuit and the multiplexer are configured to feed a corresponding portion of the imagery data into the CNN processing block in a first clock cycle to be processed in a first neighbor CNN processing engine in a next clock cycle.

20. The integrated circuit of claim 19, wherein the first CNN processing engine further comprises a clock-skew circuit and a multiplexer coupled to the CNN processing block of the first CNN processing engine, wherein the clock-skew circuit and the multiplexer are configured to feed imagery data processed by a second neighbor CNN processing engine in a previous clock cycle to the CNN processing block.
